(19) United States
(12) Patent Application Publication
(10) Pub. No.: US 2025/0168752 A1
(43) Pub. Date: May 22, 2025

(54) USER EQUIPMENT CONTEXT HANDLING

(71) Applicant: QUALCOMM Incorporated, San Diego, CA (US)

(72) Inventors: Miguel GRIOT, La Jolla, CA (US); Sebastian SPEICHER, Wallisellen (CH)

(21) Appl. No.: 18/513,180

(22) Filed: Nov. 17, 2023

(51) Int. Cl. H04W 48/16; H04W 12/041; H04W 12/06; H04W 60/04

(52) U.S. Cl. CPC H04W 48/16; H04W 12/041; H04W 12/06; H04W 60/04

(57) ABSTRACT

Various aspects of the present disclosure generally relate to wireless communication. In some aspects, a user equipment (UE) may receive a radio access network (RAN) configuration for a plurality of service modules that correspond to a plurality of services and a plurality of service-specific UE contexts. The UE may transmit, while in an inactive state, a resume identifier (ID) and one or more service indices corresponding to one or more requested services of the plurality of services. The UE may receive a response indicating one or more valid services of the one or more requested services. The UE may transmit a communication associated with a valid service of the one or more valid services. Numerous other aspects are described.

### FIELD OF THE DISCLOSURE

Aspects of the present disclosure generally relate to wireless communication and to techniques and apparatuses for handling user equipment contexts.

### DESCRIPTION OF RELATED ART

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include receiving a radio access network (RAN) configuration for a plurality of service modules that correspond to a plurality of services and a plurality of service-specific UE contexts. The method may include transmitting, while in an inactive state, a resume identifier (ID) and one or more service indices corresponding to one or more requested services of the plurality of services. The method may include receiving a response indicating one or more valid services of the one or more requested services. The method may include transmitting a communication associated with a valid service of the one or more valid services.

Some aspects described herein relate to a method of wireless communication performed by a first network entity. The method may include receiving, from a second network entity, a resume ID having identifying information associated retrieving with a UE context for a UE. The method may include transmitting, to the second network entity, a response associated with the UE context.

Some aspects described herein relate to a method of wireless communication performed by a first network entity. The method may include receiving a resume ID from a UE, the resume ID having identifying information associated with retrieving a UE context for the UE. The method may include transmitting the resume ID to a second network entity. The method may include receiving the UE context. The method may include transmitting a response to the UE.

Some aspects described herein relate to a method of wireless communication performed by a first network entity. The method may include receiving registration information from a second network entity that stores a UE context. The method may include receiving, from a third network entity, a resume ID having identifying information associated with retrieving the UE context. The method may include transmitting a response associated with the UE context.

Some aspects described herein relate to an apparatus for wireless communication at a UE. The apparatus may include one or more memories and one or more processors coupled to the one or more memories. The one or more processors may be individually or collectively configured to cause the UE to receive a RAN configuration for a plurality of service modules that correspond to a plurality of services and a plurality of service-specific UE contexts. The one or more processors may be individually or collectively configured to cause the UE to transmit, while in an inactive state, a resume ID and one or more service indices corresponding to one or more requested services of the plurality of services. The one or more processors may be individually or collectively configured to cause the UE to receive a response indicating one or more valid services of the one or more requested services. The one or more processors may be individually or collectively configured to cause the UE to transmit a communication associated with a valid service of the one or more valid services.

Some aspects described herein relate to an apparatus for wireless communication at a first network entity. The apparatus may include one or more memories and one or more processors coupled to the one or more memories. The one or more processors may be individually or collectively configured to cause the first network entity to receive, from a second network entity, a resume ID having identifying information associated with retrieving a UE context for a UE. The one or more processors may be individually or collectively configured to cause the first network entity to transmit, to the second network entity, a response associated with the UE context.

Some aspects described herein relate to an apparatus for wireless communication at a first network entity. The apparatus may include one or more memories and one or more processors coupled to the one or more memories. The one or more processors may be individually or collectively configured to cause the first network entity to receive a resume ID from a UE, the resume ID having identifying information associated with retrieving a UE context for the UE. The one or more processors may be individually or collectively configured to cause the first network entity to transmit the resume ID to a second network entity. The one or more processors may be individually or collectively configured to cause the first network entity to receive the UE context. The one or more processors may be individually or collectively configured to cause the first network entity to transmit a response to the UE.

Some aspects described herein relate to an apparatus for wireless communication at a first network entity. The apparatus may include one or more memories and one or more processors coupled to the one or more memories. The one or more processors may be individually or collectively configured to cause the first network entity to receive registration information from a second network entity that stores a UE context. The one or more processors may be individually or collectively configured to cause the first network entity to receive, from a third network entity, a resume ID having identifying information associated with retrieving the UE context. The one or more processors may be individually or collectively configured to cause the first network entity to transmit a response associated with the UE context.

Some aspects described herein relate to a non-transitory computer-readable medium that stores a set of instructions for wireless communication by a UE. The set of instructions, when executed by one or more processors of the UE, may cause the UE to receive a RAN configuration for a plurality of service modules that correspond to a plurality of services and a plurality of service-specific UE contexts. The set of instructions, when executed by one or more processors of the UE, may cause the UE to transmit, while in an inactive state, a resume ID and one or more service indices corresponding to one or more requested services of the plurality of services. The set of instructions, when executed by one or more processors of the UE, may cause the UE to receive a response indicating one or more valid services of the one or more requested services. The set of instructions, when executed by one or more processors of the UE, may cause the UE to transmit a communication associated with a valid service of the one or more valid services.

Some aspects described herein relate to a non-transitory computer-readable medium that stores a set of instructions for wireless communication by a first network entity. The set of instructions, when executed by one or more processors of the first network entity, may cause the first network entity to receive, from a second network entity, a resume ID having identifying information associated with retrieving a UE context for a UE. The set of instructions, when executed by one or more processors of the first network entity, may cause the first network entity to transmit, to the second network entity, a response associated with the UE context.

Some aspects described herein relate to a non-transitory computer-readable medium that stores a set of instructions for wireless communication by a first network entity. The set of instructions, when executed by one or more processors of the first network entity, may cause the first network entity to receive a resume ID from a UE, the resume ID having identifying information associated with retrieving a UE context for the UE. The set of instructions, when executed by one or more processors of the first network entity, may cause the first network entity to transmit the resume ID to a second network entity. The set of instructions, when executed by one or more processors of the first network entity, may cause the first network entity to receive the UE context. The set of instructions, when executed by one or more processors of the first network entity, may cause the first network entity to transmit a response to the UE.

Some aspects described herein relate to a non-transitory computer-readable medium that stores a set of instructions for wireless communication by a first network entity. The set of instructions, when executed by one or more processors of the first network entity, may cause the first network entity to receive registration information from a second network entity that stores a UE context. The set of instructions, when executed by one or more processors of the first network entity, may cause the first network entity to receive, from a third network entity, a resume ID having identifying information associated with retrieving the UE context. The set of instructions, when executed by one or more processors of the first network entity, may cause the first network entity to transmit a response associated with the UE context.

Some aspects described herein relate to an apparatus for wireless communication. The apparatus may include means for receiving a RAN configuration for a plurality of service modules that correspond to a plurality of services and a plurality of service-specific UE contexts. The apparatus may include means for transmitting, while in an inactive state, a resume ID and one or more service indices corresponding to one or more requested services of the plurality of services. The apparatus may include means for receiving a response indicating one or more valid services of the one or more requested services. The apparatus may include means for transmitting a communication associated with a valid service of the one or more valid services.

Some aspects described herein relate to a first apparatus for wireless communication. The apparatus may include means for receiving, from a second apparatus, a resume ID having identifying information associated with retrieving a UE context for a UE; and means for transmitting, to the second apparatus, a response associated with the UE context.

Some aspects described herein relate to a first apparatus for wireless communication. The apparatus may include means for receiving a resume ID from a UE, the resume ID having identifying information associated with retrieving a UE context for the UE; means for transmitting the resume ID to a second apparatus; means for receiving the UE context; and means for transmitting a response to the UE.

Some aspects described herein relate to a first apparatus for wireless communication. The apparatus may include means for receiving registration information from a second apparatus that stores a UE context; means for receiving, from a third apparatus, a resume ID having identifying information associated with retrieving the UE context; and means for transmitting a response associated with the UE context.

Aspects generally include a method, apparatus, system, computer program product, non-transitory computer-readable medium, user equipment, base station, wireless communication device, network entity, network node, and/or processing system as substantially described with reference to and as illustrated by the drawings specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture.

FIG. 4 is a diagram of an example of a core network configured to provide network slicing.

FIG. 5 is a diagram illustrating an example of a user plane protocol stack and a control plane protocol stack for a network node and a core network in communication with a UE.

FIG. 6 is a diagram illustrating an example of design models.

FIG. 7 is a diagram illustrating an example of a 5G design.

FIG. 8 is a diagram illustrating an example of a new design for networks.

FIG. 9 is a diagram illustrating an example of a New Radio (NR) system architecture, in accordance with the present disclosure.

FIG. 10 is a diagram illustrating an example of a network design, in accordance with the present disclosure.

FIG. 11 is a diagram illustrating an example of control plane services, in accordance with the present disclosure.

FIG. 12 is a diagram illustrating an example of a service based architecture, in accordance with the present disclosure.

FIG. 13 is a diagram illustrating an example of UE state management, in accordance with the present disclosure.

FIG. 14 is a diagram illustrating an example of UE context management, in accordance with the present disclosure.

FIG. 15 is a diagram illustrating an example of a UE resuming connection, in accordance with the present disclosure.

FIG. 16 is a diagram illustrating an example of UE context management, in accordance with the present disclosure.

FIG. 17 is a diagram illustrating an example of UE context management, in accordance with the present disclosure.

FIG. 18 is a diagram illustrating an example of UE context management, in accordance with the present disclosure.

FIG. 19 is a diagram illustrating an example of UE context management, in accordance with the present disclosure.

FIG. 20 is a diagram illustrating an example of using modularized UE contexts, in accordance with the present disclosure.

FIG. 21 is a diagram illustrating a continuation of the example of using modularized UE contexts, in accordance with the present disclosure.

FIG. 22 is a diagram illustrating an example of using modularized UE contexts, in accordance with the present disclosure.

FIG. 23 is a diagram illustrating an example process performed, for example, at a UE or an apparatus of a UE, in accordance with the present disclosure.

FIG. 24 is a diagram illustrating an example process performed, for example, at a first network entity or an apparatus of a first network entity, in accordance with the present disclosure.

FIG. 25 is a diagram illustrating an example process performed, for example, at a first network entity or an apparatus of a first network entity, in accordance with the present disclosure.

FIG. 26 is a diagram illustrating an example process performed, for example, at a first network entity or an apparatus of a first network entity, in accordance with the present disclosure.

FIG. 27 is a diagram of an example apparatus for wireless communication, in accordance with the present disclosure.

FIG. 28 is a diagram of an example apparatus for wireless communication, in accordance with the present disclosure.

FIG. 29 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In the early days of the internet, data networks were set up to provide many services over heterogeneous devices. One design principle of a data network model is that the model included a layered system architecture with a simple service interface spanning many applications and transports. Different transports or kinds of services can operate on the interface. With the introduction of the smart phone, 4G was successful in providing many services. The 4G protocol stack aimed to support the same model as the internet but for a cellular radio network. This involved a control plane, separate from a user plane, to manage the data transport for cellular requirements, such as mobility. Separate control and user plane protocol stacks continued the architecture defined for 3G.

As 4G expanded, new features were introduced to expand the capabilities of network communications to new use cases and device types. However, it was not possible to deploy new services without upgrading the underlying protocol. There was no simple way to add a service over the control plane as easy as it was to enable new services over an internet protocol (IP). It is a challenge to enable services to be deployed independently, while using existing protocols and allowing user equipments (UEs) to address a service directly without relying on intermediate network functions (e.g., non-access stratum (NAS) signaling, radio resource control (RRC) signaling). Furthermore, with the move to 6G, it may not be optimal to define new data collection, positioning, or other protocols in 6G and every succeeding generation (G).

In some aspects, a new network design may move away from a monolithic set of protocols with centralized control (e.g., a central unit control plane (CU-CP) and an access and mobility function (AMF)) that can make a control plane architecture quite inflexible. This may include providing individual control plane services, such as an authentication and security service, a subscription service, and a policy service, that can be requested individually. Any update to an individual service does not require an update to the whole control plane. For example, to use a service, a UE may transmit a message with an indication of a service (provided over the control plane) and a UE identifier (ID) to a radio access network (RAN) network entity. By using individually addressable services on the control plane, the UE and the network may have a more flexible deployment of services.

Another aspect of a network is the use of UE contexts. A RAN network entity may use a UE context for a UE. The UE context may be a block of information in a RAN node that is associated with an active UE. The block of information includes the information that is expected to be stored in order to maintain the network services toward the UE. However, UE contexts in 5G may have limited reusability. In 5G, there is also a hard interdependency between the RAN and the core network (CN) with respect to UE contexts. The UE context at the CN and the UE context at the RAN are handled as one UE context. This limits the area for which UE contexts may be stored and reused. For example, a target enhanced distributed unit (CDU) may be located some distance from a source eDU. If the UE context used at the source eDU cannot be stored or retrieved at the target eDU, the UE context would have to be recreated, which increases latency.

Various aspects relate generally to a UE connection to a network. In some aspects, a 6G network (or later network) may be designed with a UE context storage mechanism that makes UE contexts reusable in a larger area than allowed for 5G. The UE context storage mechanism may make a UE context available to a target eDU when a UE connects to the target eDU. For example, the UE context storage mechanism may include a discovery entity (e.g., a network entity in the CN) that has information about where the UE context for the UE may be obtained (e.g., at a source eDU or a RAN context storage (RCS) entity). The UE may receive a RAN configuration for a plurality of service modules. The RAN configuration may configure the UE to use one or more services.

The UE may have received a resume ID from a source eDU. The resume ID may include an ID that is associated with the source eDU and may be passed on to a target eDU, which uses the resume ID to retrieve a UE context during a resume procedure (UE resuming connection to an eDU from a UE inactive state). The resume ID may be unique to identification of the UE context. The resume ID may have identifying information for retrieving the UE context. For example, the identifying information may be a number or code that is unique to the UE context and that is associated with a target eDU retrieving the UE context from another network entity. In some aspects, part of the resume ID may be unique to the source eDU that stores the UE context, last stored the UE context, or that provided the UE context. The UE inactive state may include the UE not being connected to an eDU or having been released with a radio resource control (RRC) release message with an inactive identifier. The UE inactive state may be include RRC inactive, RRC idle, or RRC not connected. The UE may be in an inactive state and may transmit the resume ID to the target eDU. The target eDU may transmit the resume ID to the discovery entity, which points to the source eDU or to the RCS. The target eDU may retrieve the UE context from the source eDU or the RCS. The UE may be connected to the target eDU and may now use a valid service of the network.

Particular aspects of the subject matter described in this disclosure can be implemented to realize one or more of the following potential advantages. In some examples, by using a discovery entity and/or an RCS, the UE context may be retrievable for a UE over a larger geographical area. The UE context does not need to be recreated by the target eDU, which reduces latency.

The UE context in 6G may also be modular and reflect a service state. In some aspects, the UE contexts may be handled with UE modularized context modules, where each UE modularized context module may be active or inactive depending on the needs of the UE. For example, when the UE connects to the target eDU only for service 1, and not service 2, the UE modularized context module for service 1 is activated in the RAN, but the UE modularized context module for service 2, although stored and maintained in the RAN, is not activated (i.e., continues as inactive). By modularizing service-specific UE contexts, a single UE context does not need to have information for all services, or the same UE context is not required for each service. This provides for a more service-based handling of UE contexts, which provides more flexibility. By having such flexibility, UE contexts may be smaller and resources may be conserved.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

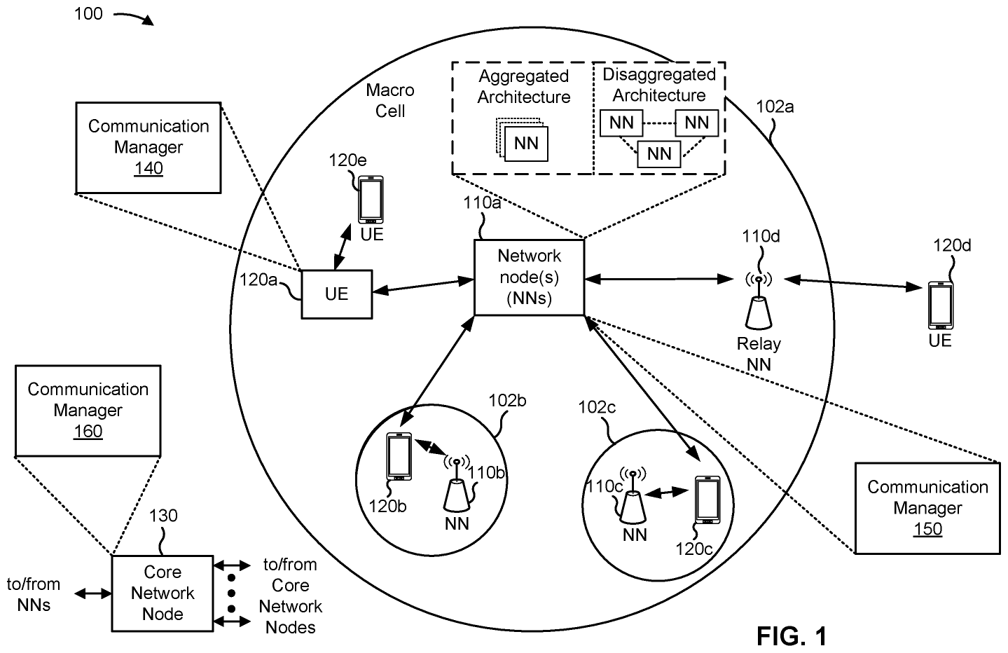

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless networks 100 may be deployed in a given geographic area. Each wireless communication network 100 may support a particular radio access technology (RAT) (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHZ. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a. FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a RAN.

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100. In some examples, a core network node 130 may be a network node that communicates with a RAN node and/or other core network nodes.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node May have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUS). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a non-terrestrial network (NTN) network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an extended reality (XR) device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an unmanned aerial vehicle or drone, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some radio access technologies (RATs) may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a UE (e.g., a UE 120) may include a communication manager 140. As described in more detail elsewhere herein, the communication manager 140 may receive a RAN configuration for a plurality of service modules that correspond to a plurality of services and a plurality of service-specific UE contexts. The communication manager 140 may transmit, while the UE is in an inactive state, a resume ID and one or more service indices corresponding to one or more requested services of the plurality of services. The communication manager 140 may receive a response indicating one or more valid services of the one or more requested services. The communication manager 140 may transmit a communication associated with a valid service of the one or more valid services. Additionally, or alternatively, the communication manager 140 may perform one or more other operations described herein.

In some aspects, a first network entity (e.g., core network node 130) may include a communication manager 160. As described in more detail elsewhere herein, the communication manager 160 may receive, from a second network entity, a resume ID associated with a UE context for a UE. The communication manager 160 may transmit, to the second network entity, a response associated with the UE context. Additionally, or alternatively, the communication manager 160 may perform one or more other operations described herein.

In some aspects, a first network entity (e.g., a network node 110) may include a communication manager 150. As described in more detail elsewhere herein, the communication manager 150 may receive a resume ID from a UE. The communication manager 150 may transmit the resume ID to a second network entity. The communication manager 150 may receive a UE context associated with the resume ID. The communication manager 150 may transmit a response to the UE. Additionally, or alternatively, the communication manager 150 may perform one or more other operations described herein.

In some aspects, a first network entity (e.g., a core network node 130) may include a communication manager 160. As described in more detail elsewhere herein, the communication manager 160 may receive registration information from a second network entity that stores a UE context. The communication manager 160 may receive, from a third network entity, a resume ID associated with the UE context; and transmit a response associated with the UE context. Additionally, or alternatively, the communication manager 160 may perform one or more other operations described herein.

As indicated above, FIG. 1 is provided as an example. Other examples may differ from what is described with regard to FIG. 1.

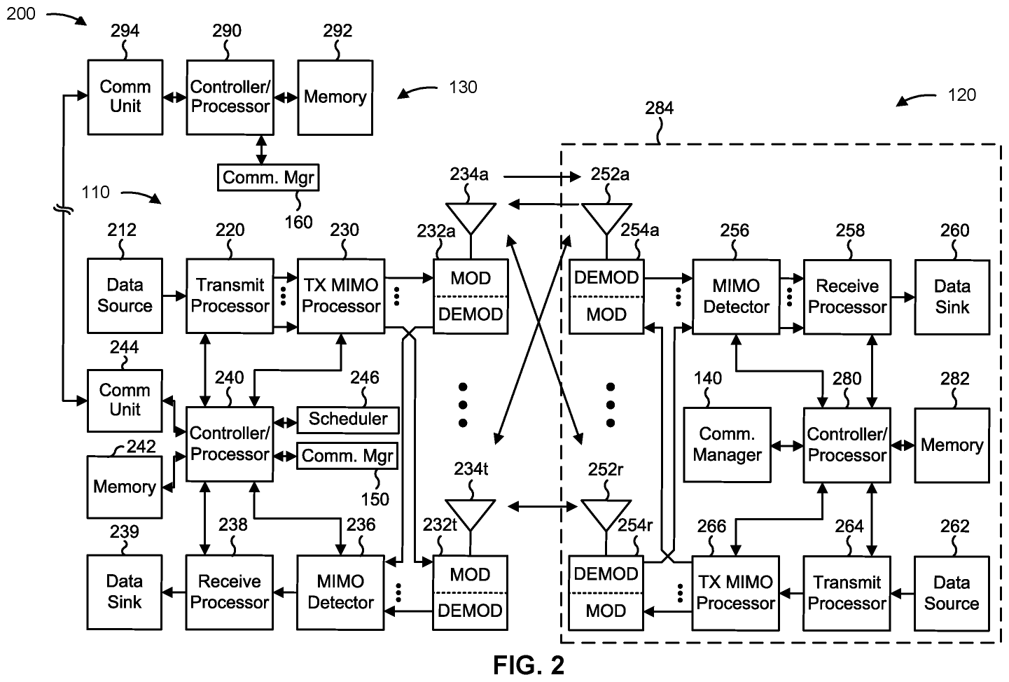

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing ((OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a channel quality indicator (CQI) parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein. “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

A core network node 130 may include one or more components of a network node 110. The core network node 130 may operate in a core network and may include a communication unit 294, a controller/processor 290, and a memory 292. The core network node 130 may communicate with another core network node 130 or network node 110 via the communication unit 294.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

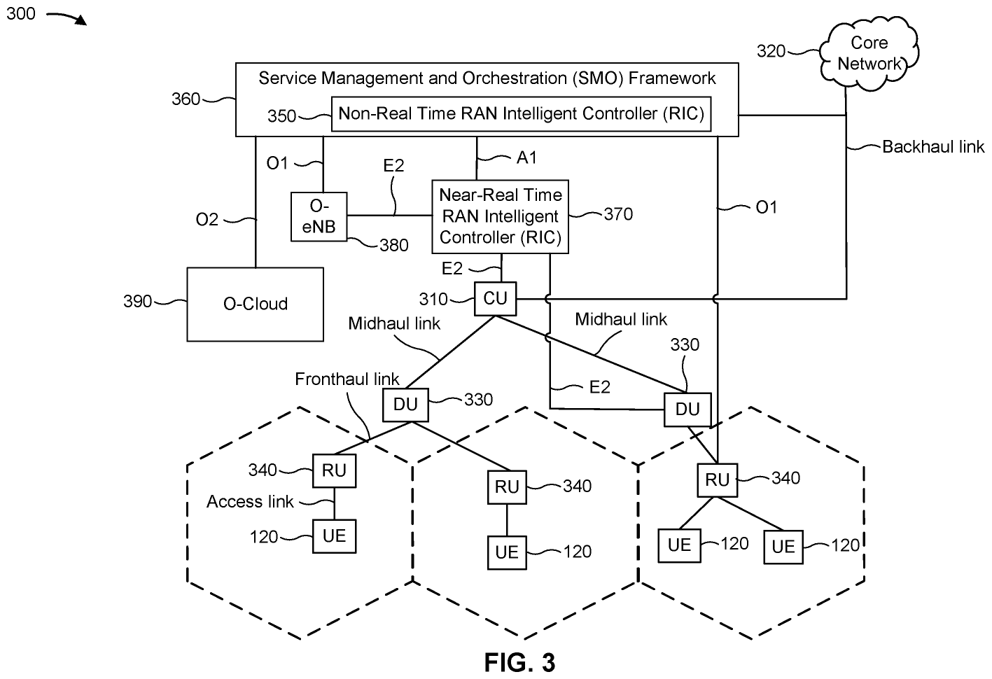

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU-UP units and one or more CU-CP units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

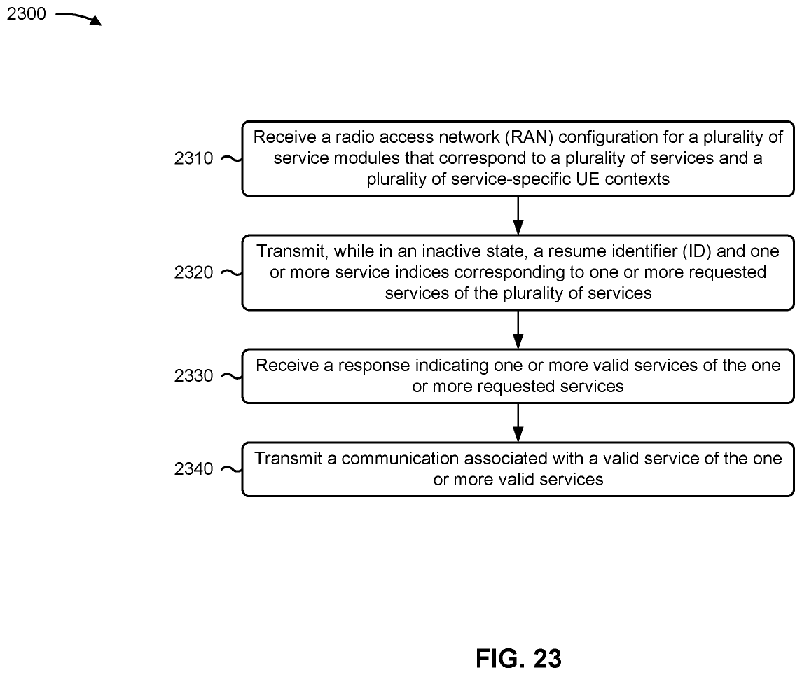

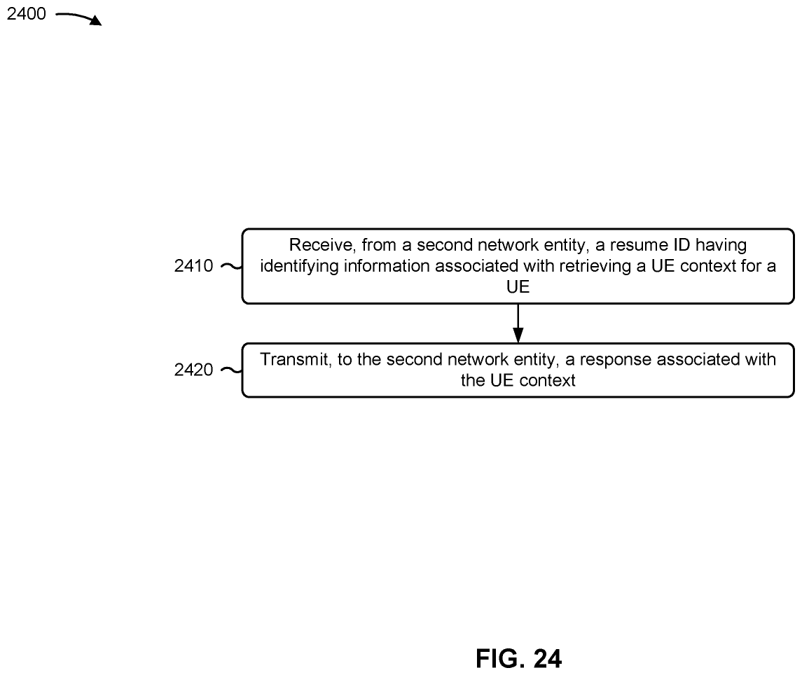

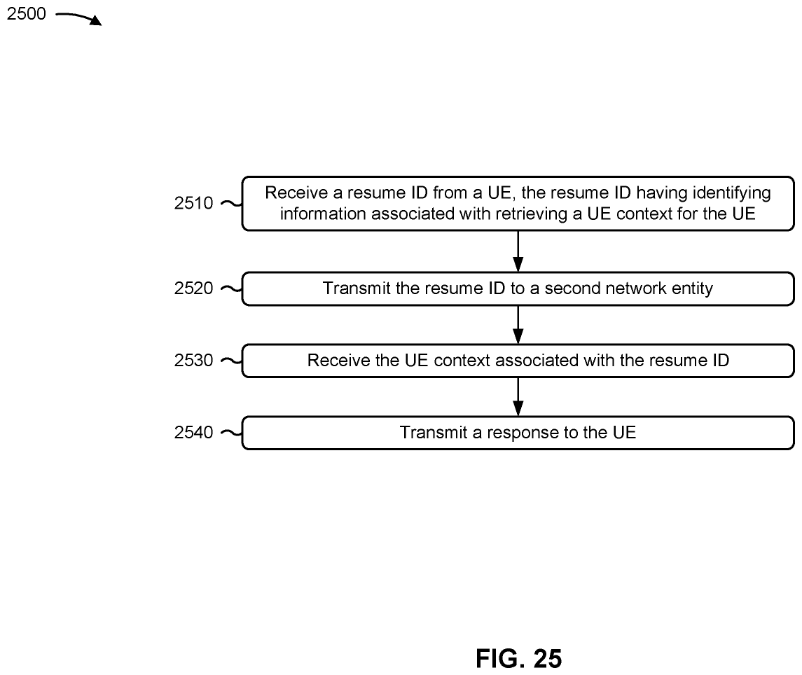

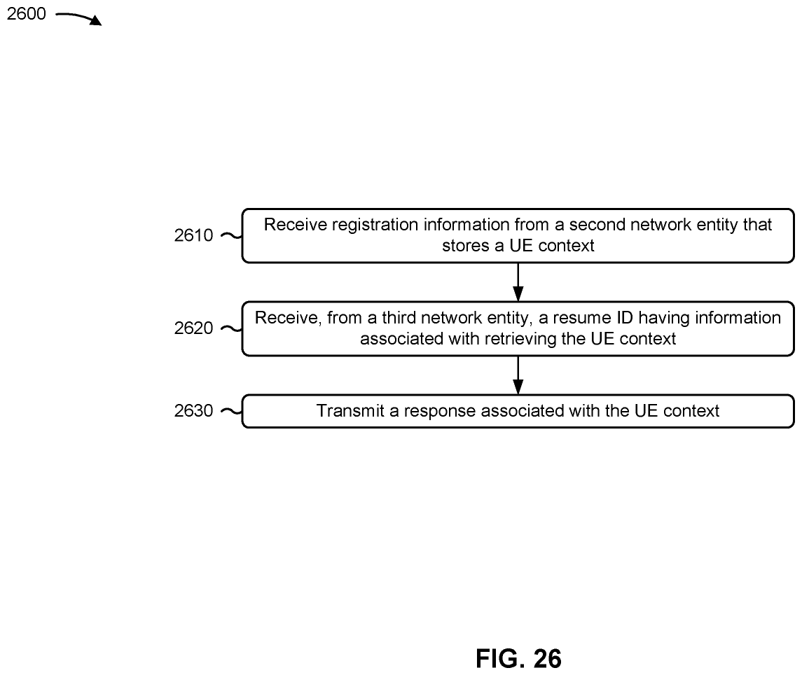

The network node 110, the controller/processor 240 of the network node 110, the UE 120, the controller/processor 280 of the UE 120, the core network node 130, the controller/processor 290 of the core network node 130, the CU 310, the DU 330, the RU 340, or any other component(s) of FIG. 1, 2, or 3 may implement one or more techniques or perform one or more operations associated with handling UE contexts, as described in more detail elsewhere herein. For example, the controller/processor 240 of the network node 110, the controller/processor 280 of the UE 120, the controller/processor 290 of the core network node 130, any other component(s) (or combinations of components) of FIG. 2, the CU 310, the DU 330, or the RU 340 may perform or direct operations of, for example, process 2300 of FIG. 23, process 2400 of FIG. 24, process 2500 or FIG. 25, process 2600 of FIG. 26, or other processes as described herein (alone or in conjunction with one or more other processors). The memory 242 may store data and program codes for the network node 110, the network node 110, the CU 310, the DU 330, or the RU 340. The memory 292 may store data and program codes for the core network node 130. The memory 282 may store data and program codes for the UE 120. In some examples, the memory 242, the memory 292, or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). The memory 292 may include one or more memories, such as a single memory or multiple different memories (of the same type or of different types). For example, the set of instructions, when executed (for example, directly, or after compiling, converting, or interpreting) by one or more processors of the network node 110, the UE 120, the core network node 130, the CU 310, the DU 330, or the RU 340, may cause the one or more processors to perform process 2300 of FIG. 23, process 2400 of FIG. 24, process 2500 or FIG. 25, process 2600 of FIG. 26, or other processes as described herein. In some examples, executing instructions may include running the instructions, converting the instructions, compiling the instructions, and/or interpreting the instructions, among other examples.

In some aspects, a UE (e.g., a UE 120) includes means for receiving a RAN configuration for a plurality of service modules that correspond to a plurality of services and a plurality of service-specific UE contexts; means for transmitting, while in an inactive state, a resume ID and one or more service indices corresponding to one or more requested services of the plurality of services; means for receiving a response indicating one or more valid services of the one or more requested services; and/or means for transmitting a communication associated with a valid service of the one or more valid services. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a first network entity (e.g., a core network node 130) includes means for receiving, from a second network entity, a resume ID associated with a UE context for a UE; and/or means for transmitting, to the second network entity, a response associated with the UE context. In some aspects, the means for the first network entity to perform operations described herein may include, for example, one or more of communication manager 160, controller/processor 290, memory 292, or communication unit 294.

In some aspects, a first network entity (e.g., a network node 110) includes means for receiving a resume ID from a UE; means for transmitting the resume ID to a second network entity; means for receiving a UE context associated with the resume ID; and/or means for transmitting a response to the UE. In some aspects, the means for the first network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a first network entity (e.g., a core network node 130) includes means for receiving registration information from a second network entity that stores a UE context; means for receiving, from a third network entity, a resume ID associated with the UE context; and/or means for transmitting a response associated with the UE context. In some aspects, the means for the first network entity to perform operations described herein may include, for example, one or more of communication manager 160, controller/processor 290, memory 292, or communication unit 294.

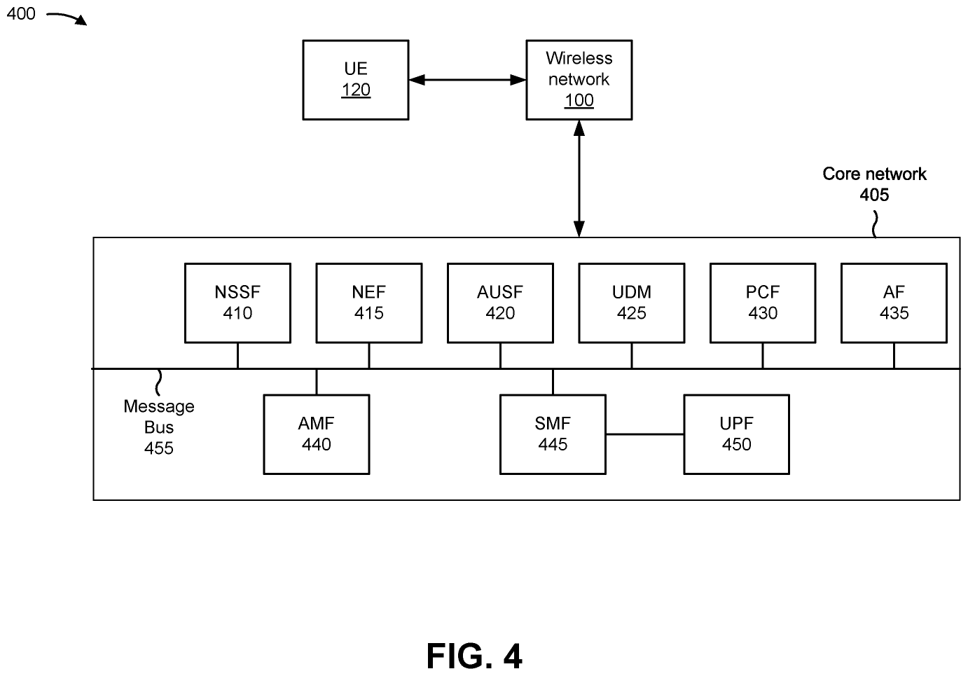

FIG. 4 is a diagram of an example 400 of a core network 405 configured to provide network slicing. As shown in FIG. 4, example 400 may include a UE 120, a wireless communication network 100, and a core network 405. Devices and/or networks of example 400 may interconnect via wired connections, wireless connections, or a combination thereof.

The wireless communication network 100 may support, for example, a cellular RAT. The network 100 may include one or more network nodes, such as base stations (e.g., base transceiver stations, radio base stations, node Bs, eNodeBs (eNBs), gNodeBs (gNBs), base station subsystems, cellular sites, cellular towers, access points, TRPs, radio access nodes, macrocell base stations, microcell base stations, picocell base stations, femtocell base stations, or similar types of devices) and other network nodes that can support wireless communication for the UE 120. The network 100 may transfer traffic between the UE 120 (e.g., using a cellular RAT), one or more network nodes (e.g., using a wireless interface or a backhaul interface, such as a wired backhaul interface), and/or the core network 405. The network 100 may provide one or more cells that cover geographic areas.

In some aspects, the wireless communication network 100 may perform scheduling and/or resource management for the UE 120 covered by the network 100 (e.g., the UE 120 covered by a cell provided by the network 100). In some aspects, the network 100 may be controlled or coordinated by a network controller, which may perform load balancing and/or network-level configuration, among other examples. As described above in connection with FIG. 1, the network controller may communicate with the network 100 via a wireless or wireline backhaul. In some aspects, the network 100 may include a network controller, a self-organizing network (SON) module or component, or a similar module or component. Accordingly, the network 100 may perform network control, scheduling, and/or network management functions (e.g., for uplink, downlink, and/or sidelink communications of the UE 120 covered by the network 100).

In some aspects, the core network 405 may include an example functional architecture in which systems and/or methods described herein may be implemented. For example, the core network 405 may include an example architecture of a fifth generation (5G) next generation (NG) core network included in a 5G wireless telecommunications system. Although the example architecture of the core network 405 shown in FIG. 4 may be an example of a service-based architecture, in some aspects, the core network 405 may be implemented as a reference-point architecture and/or a 4G core network, among other examples.

As shown in FIG. 4, the core network 405 may include a number of functional elements. The functional elements may include, for example, a network slice selection function (NSSF) 410, a network exposure function (NEF) 415, an authentication server function (AUSF) 420, a unified data management (UDM) component 425, a policy control function (PCF) 430, an application function (AF) 435, an access and mobility management function (AMF) 440, a session management function (SMF) 445, and/or a user plane function (UPF) 450, among other examples. These functional elements may be communicatively connected via a message bus 455. Each of the functional elements shown in FIG. 4 may be implemented on one or more devices associated with a wireless telecommunications system. In some implementations, one or more of the functional elements may be implemented on physical devices, such as an access point, a base station, and/or a gateway, among other examples. In some implementations, one or more of the functional elements may be implemented on a computing device of a cloud computing environment.

The NSSF 410 may include one or more devices that select network slice instances for the UE 120. Network slicing is a network architecture model in which logically distinct network slices operate using common network infrastructure. For example, several network slices may operate as isolated end-to-end networks customized to satisfy different target service standards for different types of applications executed, at least in part, by the UE 120 and/or communications to and from the UE 120. Network slicing may efficiently provide communications for different types of services with different service standards.

The NSSF 410 may determine a set of network slice policies to be applied at the wireless communication network 100. For example, the NSSF 410 may apply one or more UE route selection policy (URSP) rules. In some aspects, the NSSF 410 may select a network slice based on a mapping of a data network name (DNN) field included in a route selection description (RSD) to the DNN field included in a traffic descriptor selected by the UE 120. By providing network slicing, the NSSF 410 allows an operator to deploy multiple substantially independent end-to-end networks potentially with the same infrastructure. In some implementations, each slice may be customized for different services.

The NEF 415 may include one or more devices that support exposure of capabilities and/or events in the wireless telecommunications system to help other entities in the wireless telecommunications system discover network services. The AUSF 420 may include one or more devices that act as an authentication server and support the process of authenticating the UE 120 in the wireless telecommunications system.

The UDM 425 may include one or more devices that store user data and profiles in the wireless telecommunications system. In some aspects, the UDM 425 may be used for fixed access and/or mobile access, among other examples, in the core network 405.

The PCF 430 may include one or more devices that provide a policy framework that incorporates network slicing, roaming, packet processing, and/or mobility management, among other examples. In some aspects, the PCF 430 may include one or more URSP rules used by the NSSF 410 to select network slice instances for the UE 120.

The AF 435 may include one or more devices that support application influence on traffic routing, access to the NEF 415, and/or policy control, among other examples. The AMF 440 may include one or more devices that act as a termination point for NAS signaling and/or mobility management, among other examples. In some aspects, the AMF may request the NSSF 410 to select network slice instances for the UE 120, e.g., at least partially in response to a request for data service from the UE 120.

The SMF 445 may include one or more devices that support the establishment, modification, and release of communication sessions in the wireless telecommunications system. For example, the SMF 445 may configure traffic steering policies at the UPF 450 and/or enforce UE internet protocol (IP) address allocation and policies, among other examples. In some aspects, the SMF 445 may provision the network slice instances selected by the NSSF 410 for the UE 120.

The UPF 450 may include one or more devices that serve as an anchor point for intraRAT and/or interRAT mobility. In some aspects, the UPF 450 may apply rules to packets, such as rules pertaining to packet routing, traffic reporting, and/or handling user plane quality of service (QOS), among other examples.

The message bus 455 may be a logical and/or physical communication structure for communication among the functional elements. Accordingly, the message bus 455 may permit communication between two or more functional elements, whether logically (e.g., using one or more application programming interfaces (APIs), among other examples) and/or physically (e.g., using one or more wired and/or wireless connections).

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of example 400 may perform one or more functions described as being performed by another set of devices of example environment 400.

While FIG. 4 describes elements of a 5G network, such elements may be included in a 6G network and beyond.

As indicated above, FIG. 4 is provided as an example. Other examples may differ from what is described with regard to FIG. 4.

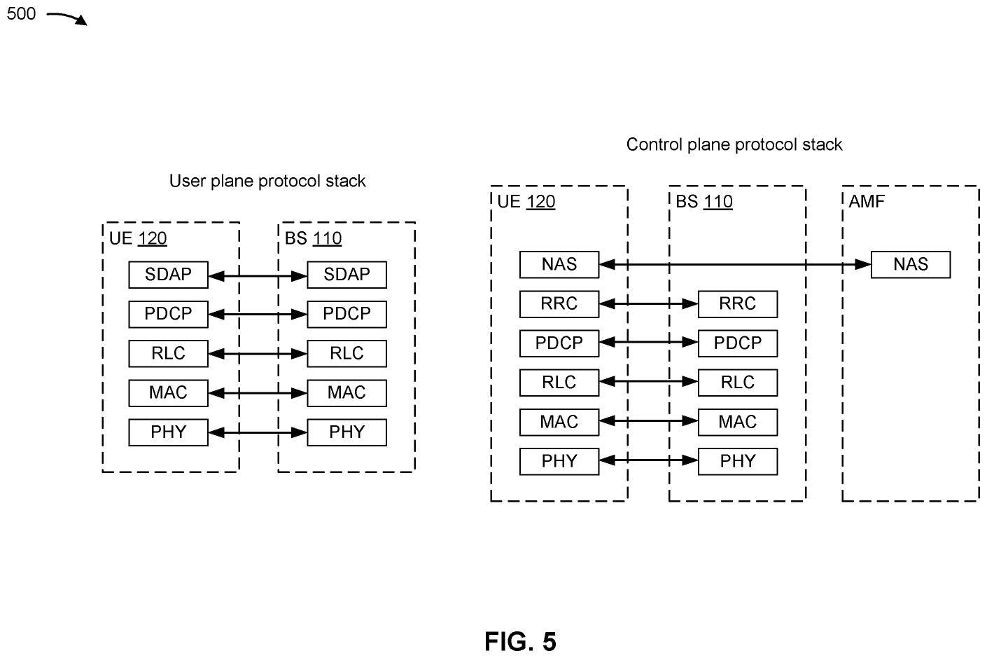

FIG. 5 is a diagram illustrating an example 500 of a user plane protocol stack and a control plane protocol stack for a network node 110 and a core network in communication with a UE 120.

In some aspects, the network node 110 may include a plurality of network nodes 110. In some aspects, protocol stack functions of the network node 110 may be distributed across multiple network nodes 110. For example, a first network node 110 may implement a first layer of a protocol stack and a second network node 110 may implement a second layer of the protocol stack. The distribution of the protocol stack across network nodes (in examples where the protocol stack is distributed across network nodes) may be based at least in part on a functional split, as described elsewhere herein. It should be understood that references to “a network node 110” or “the network node 110” can, in some aspects, refer to multiple network nodes.

On the user plane, the UE 120 and the network node 110 may include respective PHY layers, MAC layers, RLC layers, PDCP layers, and SDAP layers. A user plane function may handle transport of user data between the UE 120 and the network node 110. On the control plane, the UE 120 and the network node 110 may include respective RRC layers. Furthermore, the UE 120 may include an NAS layer in communication with an NAS layer of an AMF. The AMF may be associated with a core network associated with the network node 110, such as a 5G core network (5GC), a 6G core network, or an NG-RAN. A control plane function may handle transport of control information between the UE and the core network. Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 5, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The RRC layer may handle communications related to configuring and operating the UE 120, such as: broadcast of system information related to the access stratum (AS) and the NAS; paging initiated by the 5GC or the NG-RAN; establishment, maintenance, and release of an RRC connection between the UE and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (e.g., handover and context transfer, UE cell selection and reselection and control of cell selection and reselection, inter-RAT mobility); QoS management functions; UE measurement reporting and control of the reporting; detection of and recovery from radio link failure; and NAS message transfer between the NAS layer and the lower layers of the UE 120. The RRC layer is frequently referred to as Layer 3 (L3).

The SDAP layer, PDCP layer, RLC layer, and MAC layer may be collectively referred to as Layer 2 (L2). Thus, in some cases, the SDAP, PDCP, RLC, and MAC layers are referred to as sublayers of Layer 2. On the transmitting side (e.g., if the UE 120 is transmitting an uplink communication or the network node 110 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some aspects, the RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP service data units (SDUs), ciphering and deciphering, PDCP SDU discard (e.g., in accordance with a timer, as described elsewhere herein), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via automatic repeat requests (ARQ), segmentation and re-segmentation, reassembly of an SDU, RLC SDU discard, and RLC re-establishment.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from transport blocks (TBs) delivered to/from the physical layer on transport channels, scheduling information reporting, error correction through hybrid ARQ (HARQ), priority handling between UEs by means of dynamic scheduling, priority handling between logical channels of one UE by means of logical channel prioritization, and padding.

The MAC layer may package data from logical channels into TBs, and may provide the TBs on one or more transport channels to the PHY layer. The PHY layer may handle various operations relating to transmission of a data signal, as described in more detail in connection with FIG. 2. The PHY layer is frequently referred to as Layer 1 (L1).

On the receiving side (e.g., if the UE 120 is receiving a downlink communication or the network node 110 is receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

As indicated above, FIG. 5 is provided as an example. Other examples may differ from what is described with regard to FIG. 5.

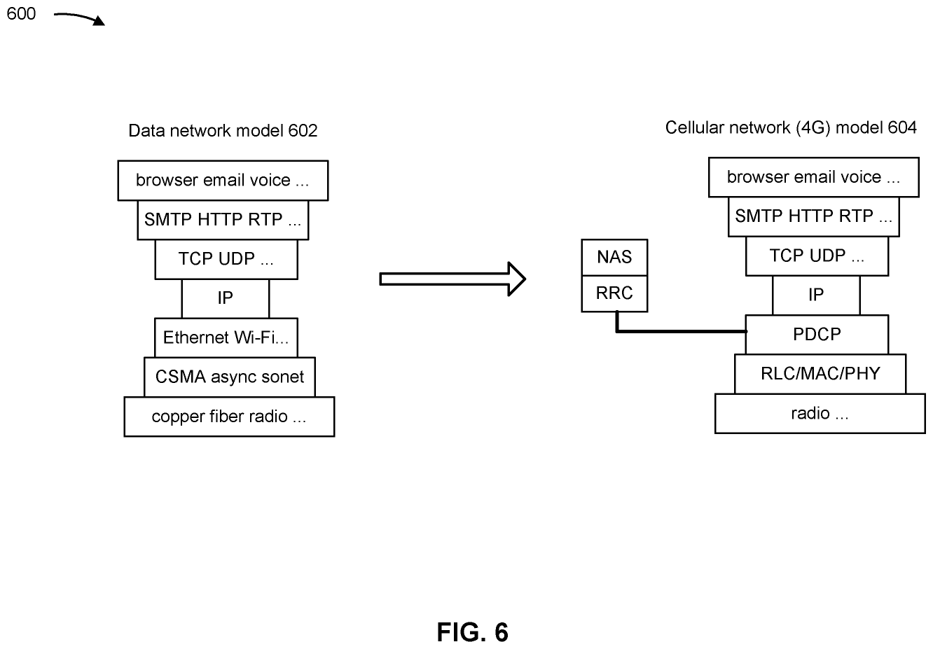

FIG. 6 is a diagram illustrating an example 600 of design models.

In the early days of the internet, data networks were set up to provide many services over heterogeneous devices. One design principle, shown by data network model 602, included a layered system architecture with a simple service interface spanning many applications and transports. The data network model 602 looked like an hourglass with an IP layer that sits in the middle and allows routing protocols to be placed on top of any type of interface. Different transports or kinds of services can operate on the interface.

With the arrival of cellular radio networks, such as 3G and 4G, the hourglass aspect of the data network model 602 was adopted, as shown by cellular network model 604. With the introduction of the smart phone, 4G was successful in providing many services. The 4G protocol stack aimed to support the same model as the internet but for a cellular radio network. This involved a control plane, separated from a user plane, to manage the data transport for cellular requirements, such as mobility. Separate control and user plane protocol stacks continued the architecture defined for 3G.

As 4G expanded new features were introduced to expand capabilities of the communication system to new use case and device types. This included expansion both horizontally (carrier aggregation (CA), dual connectivity (DC), etc.) and vertically (IoT, V2X, etc.). 4G success helped spur the expectations for 5G verticals. Additionally, services were introduced to the protocol stack as part of the NAS/RRC protocols. NAS protocol services included location. RRC protocol services included data collection, such a minimization of drive tests (MDT). Additional services provided by NAS and/or RRC, in addition to data transport and connectivity, include positioning, sensing, timing, AI/ML, etc. Service adoption of these NAS/RRC services was limited. It was not possible to deploy new services without upgrading the underlying protocol. There was no simple way to add a service over the control plane equivalent in simplicity to enabling new services over IP.

As indicated above, FIG. 6 is provided as an example. Other examples may differ from what is described with regard to FIG. 6.

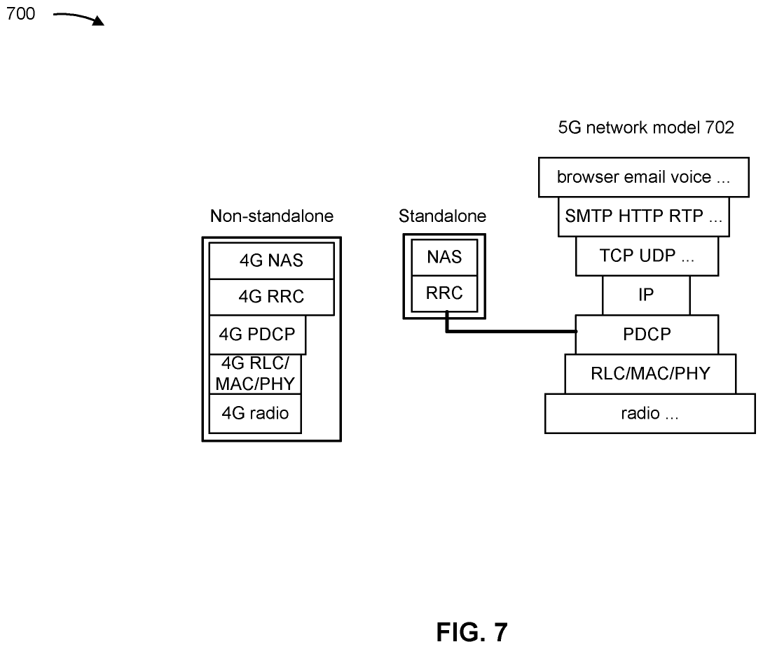

FIG. 7 is a diagram illustrating an example 700 of a 5G design.

Example 700 shows a 5G network model 702 that may be a standalone deployment or a non-standalone deployment that involve 4G. However, the 5G NAS/RRC protocol stack may have been even more monolithic than in 4G. NAS/RRC continues to grow to support even more features such as Industrial IoT, satellites, etc. Service revenue has concentrated in the user plane as support for traditional services continued from the 4G era. History further suggests limited adoption of control plane services. There have been differentiated services built on network slices as a potential feature to drive 5G standalone deployments. Policy and charging functions allow new revenue streams beyond data consumption.

It is a challenge to enable services to be deployed independently, while using existing protocols and allowing UEs to address a service directly without relying on intermediate network functions (e.g., NAS signaling, RRC signaling). Furthermore, with the move to 6G, it may not be optimal to define new data collection, positioning, or other protocols in 6G and every succeeding G.

As indicated above, FIG. 7 is provided as an example. Other examples may differ from what is described with regard to FIG. 7.

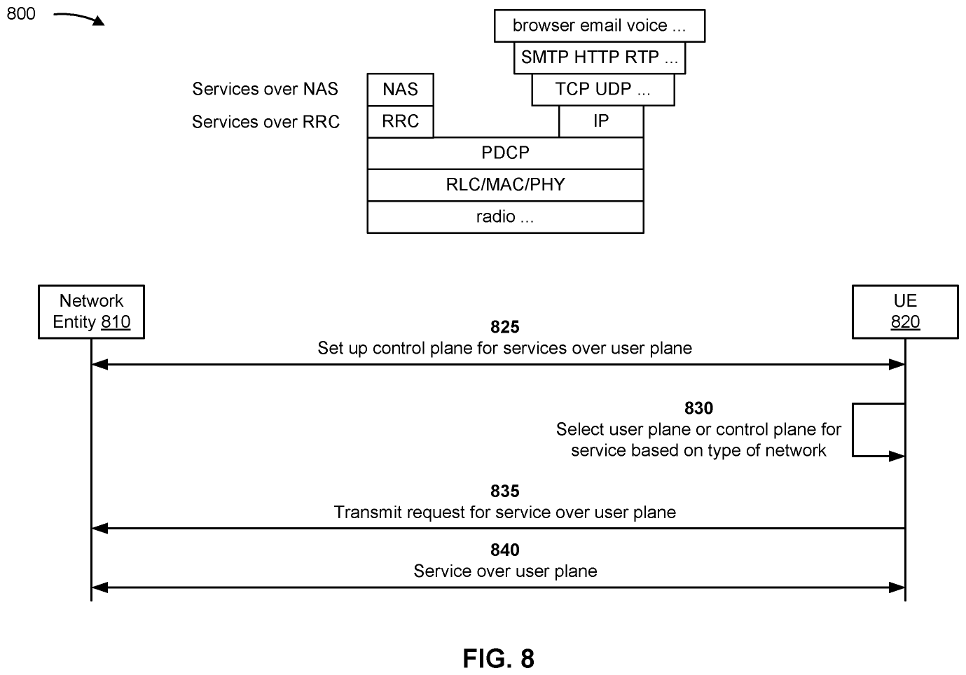

FIG. 8 is a diagram illustrating an example 800 of a new design for networks. As shown in FIG. 8, a network entity 810 (e.g., network node 110) and a UE 820 (e.g., a UE 120) may communicate with one another via a wireless network (e.g., including element of wireless communication network 100). The network may be a 5G network, a 6G network, a later generation network, or a combination of such networks.

In some aspects, a new network design may involve moving away from defining a G-specific control plane for every G and enabling the hourglass model on the control plane. This may include defining what is hosted in the control plane in a user plane first approach. A thinner control plane for 6G may make control plane services available in 5G and other RATs. Control plane services, including location and data collection, may be available (e.g., upon an address request) over the user plane and may become G-independent using standardized APIs. Services address and executed over the user plane may include a data session, a PDU session, a sensing service, a location service, a policy service, UE device management, and/or a policy download on the UE.

The new design may leverage the scale of internet services and protocols to enable many potential vendors for these services instead of the restricted few infra vendors today. The new design may include simplify how remaining services are enabled over NAS and RRC. The control plane may not be G-specific, and NAS and RRC may be defined just as a transport layer for services. Services may be decoupled from the transport. For example, a service interface may be enabled such that connectivity, session management, and other services are built on top of NAS and RRC instead of incorporated in the NAS protocol.

In some aspects, the NAS layer may be common across services. The NAS layer may provide for service discovery, routing, and late binding. The transport layer may be at the service entry point. The same transport layer may be used for both the user plane and the control plane with no differences from a protocol standpoint. Services may be differentiated via a service ID. Reliability and security may be implemented at the transport/service layer or relocated per service requirements. Microservices behind the service entry point may be transparent to other parts of the system (e.g., including the UE). In some aspects, the UE may use a service ID, a NAS ID, a paging ID, and/or a RAN ID. The UE may use such IDs to address a service directly over the user plane. The NAS/RRC layer may be used for authentication, some mobility services, and for setting up the user plane.

By using the NAS protocol and RRC signaling as a transport/service layer to set up services that operate on the user plane, the adoption of services on the network may expand and create new revenue streams, while limiting the redefinition of the control plane with future generations.

Example 800 shows an example of the UE 820 requesting a service over a user plane. At 825, the network entity 810 and the UE 820 may set up a control plane (e.g., NAS protocols, RRC signaling) for services over a user plane. This may include setting up a NAS/RRC layer to operate as a transport for services that may have been handled by the control plane in earlier networks. The setup of the control plane may involve authentication of the UE 820 for requesting services.

In some aspects, at 830, the UE 820 may select to use the user plane or the control plane to request a service based at least in part on a type of network. For example, the UE 820 may select the user plane if the network is 6G, or select the control plane if the network is 5G. Selection between the user plane or control plane may be based on the G (6G+vs. 3G/4G/5G) of the network connection. Selection between the user plane or control plane may be based at least in part on a service or service type. Selection between the user plane or control plane may be based at least in part on a UE configuration, a user preference, or service availability. The service may be the type of service that would have normally been handled by the control plane, such as MDT or managing a QoS. In an example, the UE 820 may select the control plane if the service is for managing a QoS. The service may be the type of service that uses a signaling radio bearer (SRB) in 5G. A service protocol may not be affected by whether the transport is over a control plane or the user plane.

In some aspects, the control plane may be a thinner control plane that provides less service and those services are provided on the user plane. That is, some services of the control plane may be replaced with services on the user plane. A thinner control plane for 6G may have fewer protocols or signaling than used for 5G.

At 835, if the UE 820 selects the user plane, the UE 820 may transmit a request for the service over the user plane. This may include addressing the service using a user plane address. This may include using a service ID, a RAN ID, and/or a NAS ID. At 840, the UE 820 may execute the service over the user plane.

In some aspects, the UE 820 may use a specific PDU session and/or dedicated physical resource blocks (PRBs) that provide for a higher priority on the user plane so as to not increase latency over what is expected for the control plane.

As indicated above, FIG. 8 is provided as an example. Other examples may differ from what is described with respect to FIG. 8.

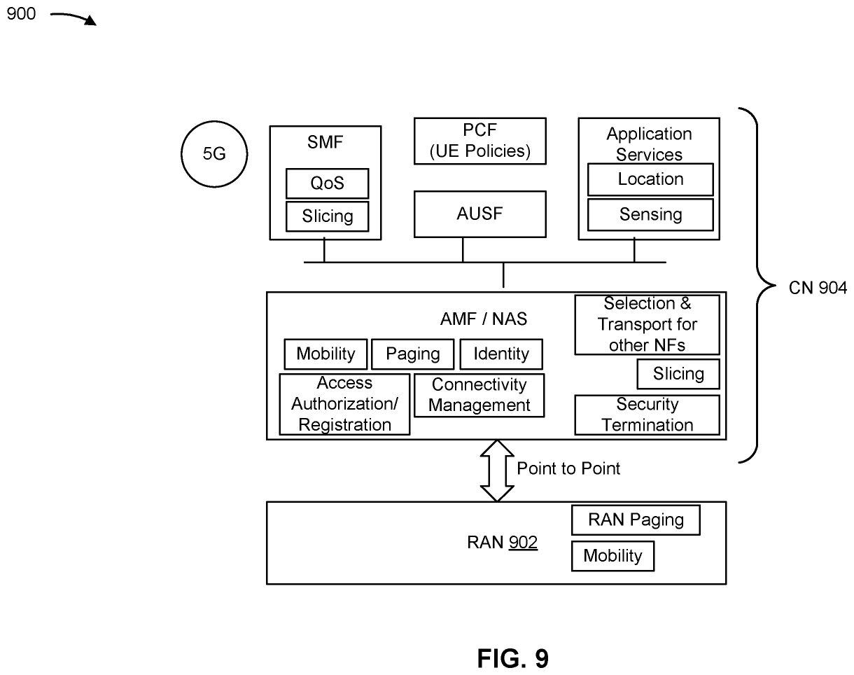

FIG. 9 is a diagram illustrating an example 900 of an NR system architecture, in accordance with the present disclosure.

Example 900 shows an NR architecture for 5G. The NR architecture may include a RAN 902 and network functions in a core network 904. The RAN 902 may perform RAN paging or mobility functions. The core network 904 may include an AMF that uses NAS protocols to provide functions for a UE. The functions may include: mobility; paging; identity; access, authorization, and registration; connectivity management; selection and transport; slicing; and security termination. Application services over the control plane may include SMF services (e.g., QoS, slicing), PCF services, AUSF services, location services, and sensing services. Each of these services have an arbitrary interdependency on the AMF. That is, all core network functions depend on the AMF. Also, the mobility management layer is involved in slicing management, which is a service concept and thus an inefficient split of network functionalities. There is also repeated functionality in the RAN and the core network. All of these services in the control plane involve single vendor deployments that are hard to extend beyond the first release.

In addition, there is only one control plane path between the RAN 902 and the core network 904. This forces the architecture to add functionality into the AMF that is not actually relevant to access and mobility management. This single control plane path also creates interdependencies between the AMF and the RAN 902. A single monolithic set of protocols at the control plane (e.g., NAS protocols, RRC protocols) with centralized control (e.g., a CU-CP, an AMF) makes the network design less flexible to add new features.

As indicated above, FIG. 9 is provided as an example. Other examples may differ from what is described with regard to FIG. 9.

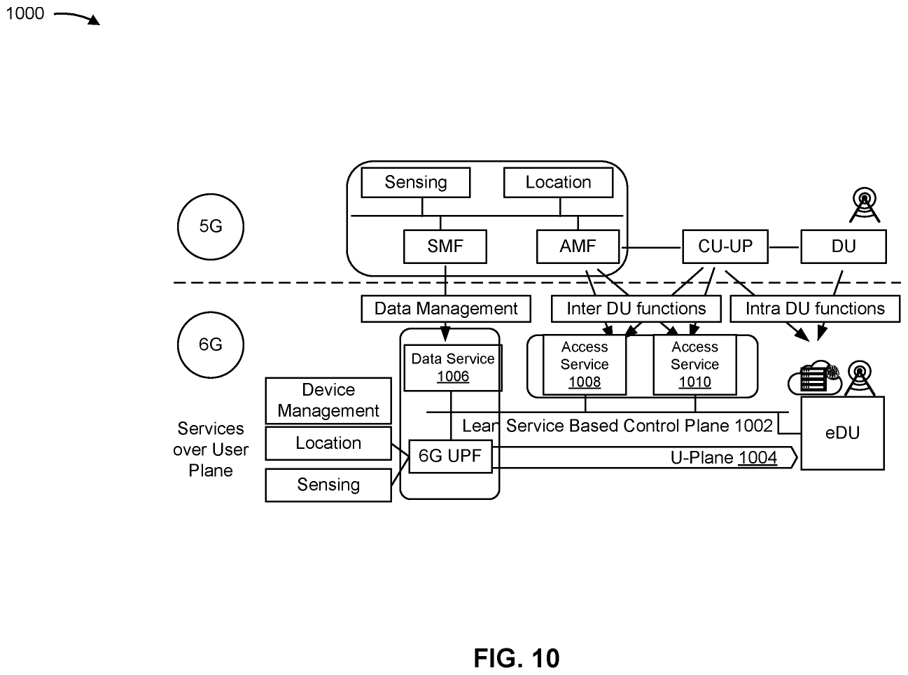

FIG. 10 is a diagram illustrating an example 1000 of a network design, in accordance with the present disclosure.

In some aspects, a new network design may move away from a monolithic set of protocols with centralized control. This may include providing individual, modular control plane services, such as an authentication and security service, a subscription service, and a policy service, that can be requested individually. Any update to an individual service does not require an update to the whole control plane. For example, a UE may transmit a message with an indication of a service (provided over the control plane) and a UE ID to a RAN network entity. The message may include a control plane transport header on a control plane transport layer that is used for forwarding the message to an address for the service. The RAN network entity may determine the address mapped to the service and forward the message to the address. The service entity at the address may transmit a configuration for the service, which is forwarded to the UE. The UE may use the service over the control plane. In some aspects, the core network may provide a discovery and selection service for locating the addresses for services.

By using individually addressable services on the control plane, the UE and the core network may use more flexible deployments of services and features. The core network may support a more distributed functionality, where the UE can communicate directly with each functionality (service). The UE to be able to communicate with any service over the control plane, with a control plane transport that is common to and independent of the control plane services. The UE may discover an address to a service while the network hides the network topology. New or enhanced services may be added later without affecting the control plane transport at the RAN or intermediate nodes. As a result, updates to the control plane may be quicker and involve less disruption of services. This may also improve the adoption of services on the network and create new revenue streams, while limiting the redefinition of the control plane with future generations.

Example 1000 shows an example network design with an end-to-end system architecture for future generations, such as 6G. The network design shows modular control plane protocols with a cloud native service based architecture. A lean, service-based control plane 1002 may provide individual access services 1006, 1008, and 1010 normally provided by the AMF. Some services, such as device management, location, sensing, and data service may be provided over the control plane 1002 or the user plane 1004.

The new design may involve modularization and RAN/core network convergence. Network functionality may be modularized into self-contained service modules. The functionality of the RAN and the core network may converge. The NAS protocols and the UE contexts may be modular. The leaner control plane may be focused on access, connectivity, mobility, and data services. Non-connectivity services may be moved to the user plane.

This new design may allow for an inter-vendor and intra-vendor network functionality split. The new design may enable the faster and easier adoption of new verticals. The new design may allow for forward compatibility to evolved and new features with minimum network impact.

As indicated above, FIG. 10 is provided as an example. Other examples may differ from what is described with regard to FIG. 10.

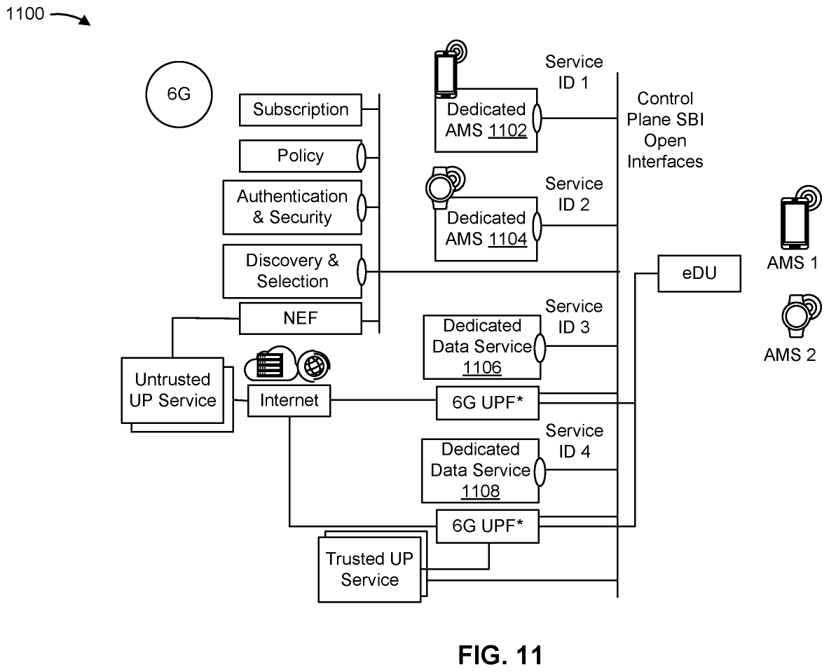

FIG. 11 is a diagram illustrating an example 1100 of control plane services, in accordance with the present disclosure.

Example 1100 shows that dedicated services may be addressable by service ID. Control plane services may include, for example, subscription, policy, authentication and security, discovery and selection, and an NEF. Control plane services may also include a different access and mobility service (AMS) for specific types of devices (e.g., RedCap. IoT, smartphone). Different vendors may provide specialized solutions. In some aspects, these dedicated AMS services may each be identified by a service ID. For example, AMS service 1102 may be identified by service ID 1, and AMS service 1104 may be identified by service ID 2.

User plane services may include dedicated data services, each identified by a service ID. Multiple data service slices (DSSs) per UE may be possible. A DSS may interact directly with the UE and a DU (e.g., eDU). A DSS may interact with an AMS (e.g., for mobility area, paging). A DSS may interact with an authentication and security service to derive its own security context. DSS 1106 may be identified by service ID 3, and DSS 1108 may be identified by service ID 4.

As indicated above, FIG. 11 is provided as an example. Other examples may differ from what is described with regard to FIG. 11.

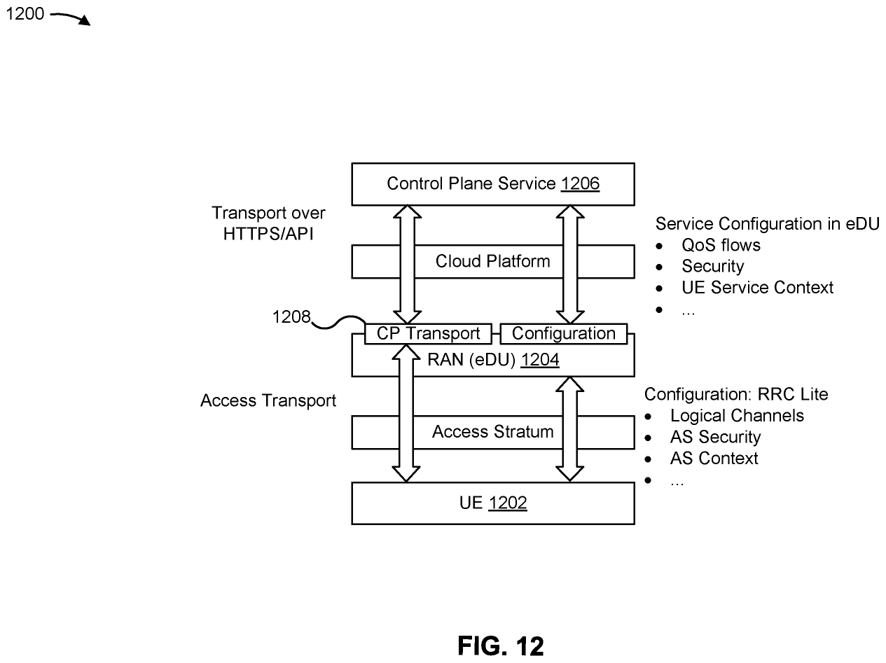

FIG. 12 is a diagram illustrating an example 1200 of a service based architecture, in accordance with the present disclosure.

In some aspects, a UE 1202 may signal a control plane service 1206 using a control plane transport 1208 in an end-to-end control plane signaling solution. The control plane transport 1208 may be a common transport for all services. The RAN 1204 may be involved only in routing, with no insight into with which service the UE 1202 is communicating. The end-to-end security may be independent of the specific service (support of zero trust paradigm).

In some aspects, there may be one or more control plane transport APIs between the RAN 1204 and the control plane service 1206. The APIs may leverage service-based interfaces (SBIs). The control plane service 1206 may use a configuration API to request a specific RAN configuration. The RAN may aggregate requests for different services and may accept, modify, or reject requests.

The UE 1202 may use the control plane transport 1208 to request services and to receive configurations for services. A configuration may be a local configuration. The configuration may be a service-specific configuration (e.g., logical channels corresponding to QoS flows) or a service-agnostic configuration that is intrinsic to eDU-UE connected operation and common to all services.

As indicated above, FIG. 12 is provided as an example. Other examples may differ from what is described with regard to FIG. 12.

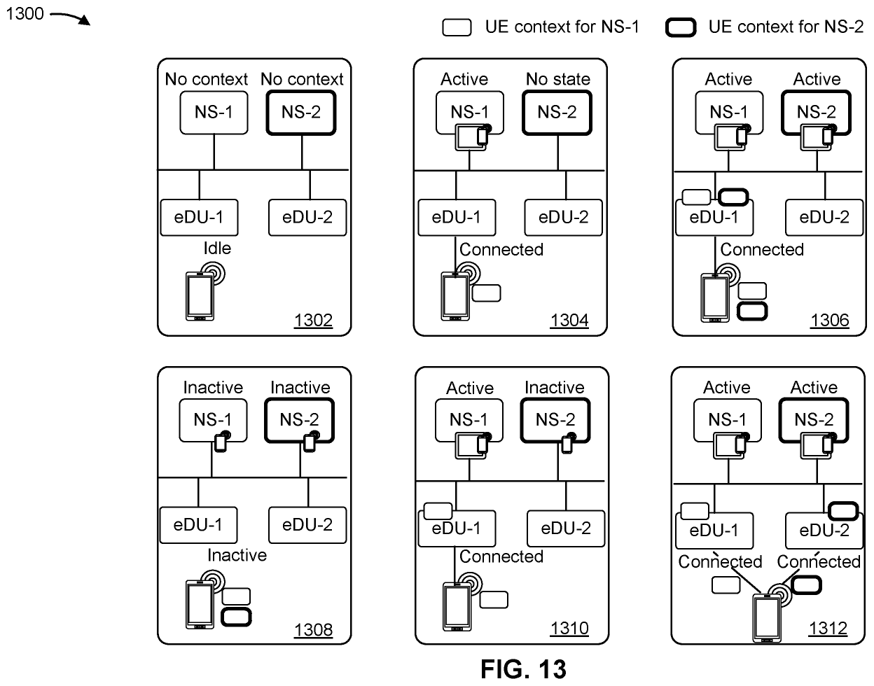

FIG. 13 is a diagram illustrating an example 1300 of UE state management, in accordance with the present disclosure.

UE state management in 5G may involve a relatively rigid and centralized state management, managed by the CU-CP and the AMF. Possible UE states may include, for example, RRC/CN CONNECTED, RRC INACTIVE/CN CONNECTED, and RRC/CN IDLE. UE state management for 6G may be more service-centric. That is, the state may be managed per service, and the states may be active or inactive.

Example 1300 shows different scenarios involving UE states for network services (NSs), such as NS-1 and NS-2. A UE state at a RAN may be not connected (no UE RAN connection), where the UE RAN context may be stored in both the UE and the RAN. A UE state at the RAN may be connected, where there is an active RAN connection with a network entity (e.g., eDU-1, eDU-2) in the RAN.

A UE state may be per service. A state may be maintained at each service independently. Some services may have interdependencies. There may be no context for the UE state for a service (equivalent to the UE not being registered for the service). A UE state for a service may be active, where there is a context at the UE, the service, and possibly the eDU. A UE state for a service may be inactive, where there is context at the UE or the service, but the service may not know the serving eDU.

In scenario 1302, the UE may be idle (not connected) and there are no UE contexts stored for NS-1 or NS-2. In scenario 1304, the UE may be connected to eDU-1. NS-1 may be active and NS-2 may have no state. A UE context for NS-1 is stored at the UE. In scenario 1306, the UE is connected to eDU-1, NS-1 is active, and NS-2 is active. UE contexts for NS-1 and NS-2 are stored at the UE and eDU-1. In scenario 1308, the UE is inactive, NS-1 is inactive, and NS-2 is inactive. UE contexts for NS-1 and NS-2 are stored at the UE. In scenario 1310, the UE is connected to eDU-1, NS-1 is active, and NS-2 is inactive. A UE context for NS-1 is stored at the UE and eDU-1. In scenario 1312, the UE is connected to eDU-1 and eDU-2, NS-1 is active, and NS-2 is active. A UE context for NS-1 is stored at eDU-1 and a UE context for NS-2 is stored at eDU-2.

As indicated above, FIG. 13 is provided as an example. Other examples may differ from what is described with regard to FIG. 13.

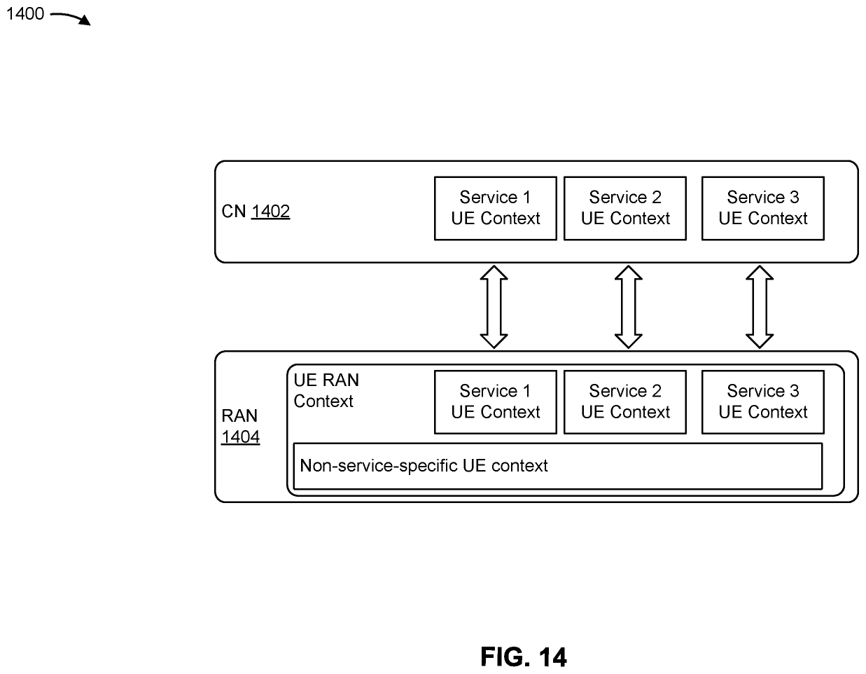

FIG. 14 is a diagram illustrating an example 1400 of UE context management, in accordance with the present disclosure.

UE RAN contexts in 5G may have limited reusability. A UE RAN context may include a UE context used by a RAN node (e.g., eNB). The UE context may be a block of information in a RAN node that is associated with an active UE. The block of information includes the information that is expected to be stored in order to maintain the network services toward the active UE. The UE context may include at least UE state information, security information, UE capability information, and the identities of the UE-associated logical S1 connections. The UE context is established when the transition to active state for a UE is completed or when the UE context is in the target network entity after completion of handover resource allocation during handover preparation. The UE context may be local. The UE context may be suspended or resumed as a whole.

In 5G, there is a hard interdependency between the RAN and the CN with respect to UE contexts. The UE context at the CN and the UE context at the RAN are handled as one UE context. This limits the area for which UE contexts may be stored and reused. For example, a target eDU may be located some distance from a source eDU. If the UE context used at the source eDU cannot be stored or retrieved at the target eDU, the UE context would have to be recreated, which increases latency.

In some aspects, UE contexts may be modularized in a 6G network. The modularization in the 6G CN may translate into a more modular management of UE contexts. Each service may expect a service-specific RAN configuration. For example, a security service may request access-stratum (AS) security or a data service may expect specific QoS flows or DRBs. A service-specific RAN configuration and the UE context specific to the service may be handled as a self-contained module, in accordance with the specific service state and needs.

Example 1400 shows an example of UE context management, where service-specific UE contexts for a UE may be used at the CN 1402 or stored at the RAN 1404. Non-service-specific UE contexts may also be stored at the RAN 1404. In example 1400, service 1 goes inactive (e.g., data service goes inactive after no data for a certain time). The RAN 1404 may render the Service 1 UE context inactive, keep the Service 1 UE context, and quickly resume the UE context module for the Service 1 UE context when Service 1 becomes active for the UE.

As indicated above, FIG. 14 is provided as an example. Other examples may differ from what is described with regard to FIG. 14.

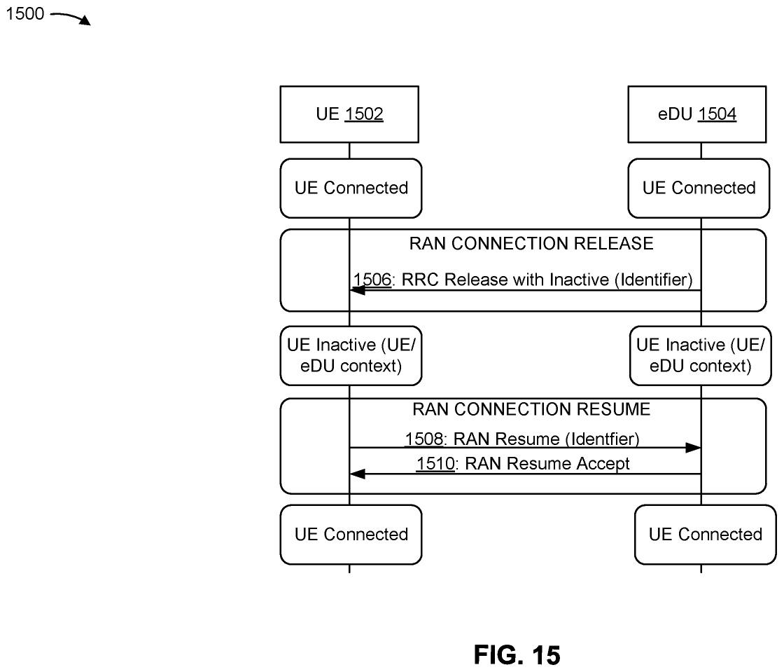

FIG. 15 is a diagram illustrating an example 1500 of a UE resuming connection, in accordance with the present disclosure.

Example 1500 shows a UE 1502 that is connected to an eDU 1504, goes inactive, and then reconnects to the eDU 1504 as part of an intra-eDU connection management mechanism. The UE 1502 that is connected to the eDU 1504 may receive a RAN connection release message (shown at 1506) with an identifier. The UE 1502 may go inactive. The eDU 1504 may maintain the UE context.

When the UE 1502 is to go active, the UE 1504 may transmit a RAN resume message (shown at 1508) with an identifier to the eDU 1504 and receive a RAN resume accept message (shown at 1510). The UE 1502 may then be connected again.

The eDU 1504 may indicate to the UE 1502 to keep the UE context for the UE 1502. The UE context may include or correspond to an eDU local access configuration. If the UE 1502 resumes connection in the same eDU 1504, the UE 1502 may reuse the UE context, without need for an AS security mode command (SMC) and an RB reconfiguration. However, the UE context is still limited in area to the eDU's 1504 coverage.

As indicated above, FIG. 15 is provided as an example. Other examples may differ from what is described with regard to FIG. 15.

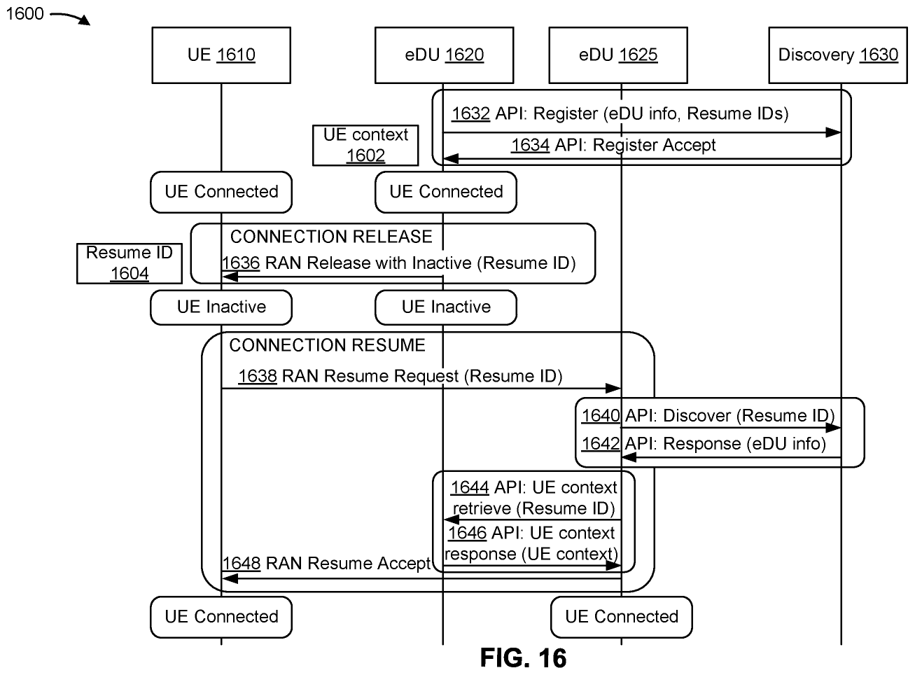

FIG. 16 is a diagram illustrating an example 1600 of UE context management, in accordance with the present disclosure.

A 6G network (or later network) may be designed such that UE contexts are reusable in a larger area (e.g., in a larger registration area) than allowed for 5G. The 6G network may make use of a service-based architecture (cloud solution), such that UE contexts are retrievable in an inter-eDU mechanism wherever the UE resumes connection, even over greater distances between eDUs. The UE RAN context may be modular and reflect a service state.

According to various aspects described herein, the 6G network may use a UE context storage mechanism such that UE contexts are stored and reachable over a larger geographical area. The UE context may be available to a target eDU when a UE connects to the target eDU. For example, the 6G network may include a discovery entity (e.g., network entity in the CN) that has information about where the UE context for the UE may be obtained (e.g., at a source eDU or an RCS entity). The UE may transmit a resume ID to the target eDU. The target eDU may transmit the resume ID for the UE to the discovery entity, which points to the source eDU or the RCS. The target eDU may retrieve the UE context from the source eDU or the RCS. In this way, the UE context may be retrievable for a UE over a larger geographical area. The UE context does not need to be recreated by the target eDU, which reduces latency.

In some aspects, the UE contexts may be handled with RAN context modules, where each RAN context module may be active or inactive depending on the needs of the UE. For example, when the UE connects to the target eDU only for service 1, and not service 2, the UE RAN context module for service 1 is activated in the RAN, but the UE RAN context module for service 2, although stored and maintained in the RAN, is not activated (i.e., continues as inactive). By modularizing service-specific UE contexts, a single UE context does not need to have information for all services, or the same UE context is not required for each service. This provides for a more service-based handling of UE contexts, which provides more flexibility. By having such flexibility, UE contexts may be smaller and resources may be conserved.

In example 1600, a network (e.g., wireless communication network 100) may use a discovery entity 1630 (e.g., network node 110, core network node 130) for UE context management. The discovery entity 1630 may store information about eDUs (e.g., identification, internet protocol (IP) address) and resume IDs associated with the eDUs. A resume ID may be used to identify which eDU stores a UE context 1602 for a UE 1610 (e.g., UE 120). The UE context 1602 may include a local access configuration (e.g., RB configuration, a security context) for the UE 1610.

The UE 1610 may be connected to a source eDU 1620 (e.g., network node 110). The eDU 1620 may store the UE context 1602 for the UE 1610. The UE 1610 may also connect to a target eDU 1625 (e.g., network node 110). Either eDU may communicate with the discovery entity 1630. The discovery entity 1630 may be accessible by multiple eDUs over a larger geographical area.

In some aspects, the eDU 1620 may register with the discovery entity 1630. As shown by reference number 1632, the eDU 1620 may transmit, to the discovery entity 1630, a registration message with eDU information for the eDU 1620 and one or more resume IDs that may be used for finding a UE context at the eDU 1620. The registration message may be transmitted using an application programming interface (API). As shown by reference number 1634, the eDU 1620 may receive a register accept message.

The UE 1610 may be connected to the eDU 1620. For some reason, the UE 1610 is to go inactive. As shown by reference number 1636, the UE 1610 may receive a RAN connection release message with a resume ID 1604 from the eDU 1620. The resume ID may be associated with retrieving a UE context. The resume ID may include identifying information associated with retrieving a UE context. The resume ID 1604 may include some part that is unique to the eDU 1620. The UE 1610 may then go inactive. The eDU 1620 may maintain (store) the UE context 1602 for the UE 1610.

The UE 1610 may reconnect to an eDU, such as to a target eDU 1625. As shown by reference number 1638, the UE 1610 may transmit a RAN resume request message with the resume ID 1604 to the eDU 1625. As shown by reference number 1640, the eDU 1625 may transmit a discover message with the resume ID 1604 to the discovery entity 1630. As shown by reference number 1642, the discovery entity 1630 may transmit a response message with eDU information to the eDU 1625. The eDU information may identify the eDU 1620, which is where the UE 1610 last connected. As shown by reference number 1644, the eDU 1625 may transmit a UE context retrieve message with the resume ID 1604 to the eDU 1620. As shown by reference number 1646, the eDU 1620 may transmit a UE context response message with the UE context 1602 to the eDU 1625. As shown by reference number 1648, the eDU 1625 may transmit a RAN resume accept message to the UE 1610. The UE 1610 and the eDU 1625 may reuse a previous RAN configuration. The UE is now connected to the eDU 1625, where the eDU 1625 is able to use the UE context 1602 for connection with the UE 1610.

As indicated above, FIG. 16 is provided as an example. Other examples may differ from what is described with regard to FIG. 16.

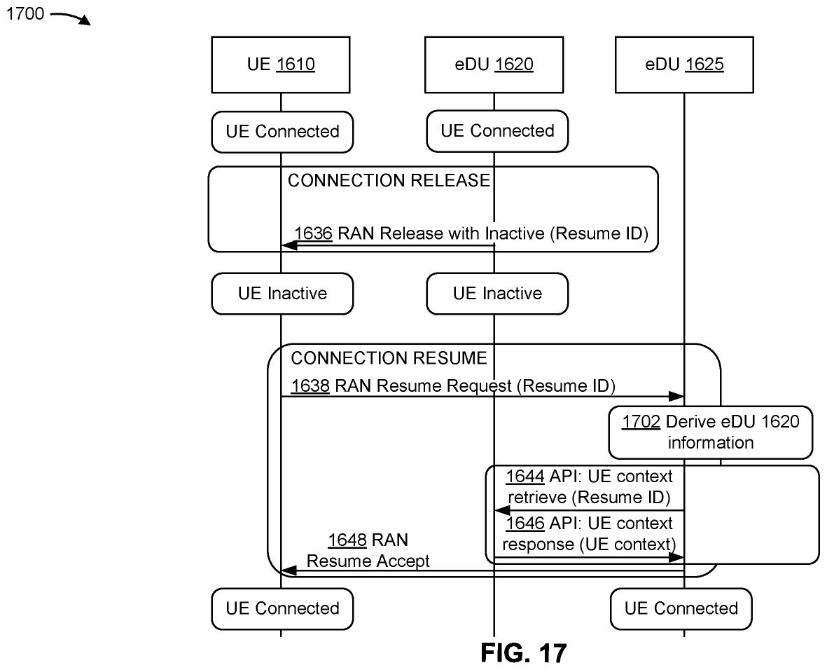

FIG. 17 is a diagram illustrating an example 1700 of UE context management, in accordance with the present disclosure.

In some aspects, the eDU 1625 may derive the eDU information for the eDU 1620 without using a discovery entity. As shown by reference number 1702, the eDU 1625 may derive the eDU 1620. The eDU 1625 may derive information for the eDU 1620 using operations, administration, and maintenance (OAM) information. The eDU 1625 may derive the information for the eDU 1620 using an eDU ID in the resume ID. The eDU 1625 may derive the information for the eDU 1620 using previously cached information.

As indicated above, FIG. 17 is provided as an example. Other examples may differ from what is described with regard to FIG. 17.

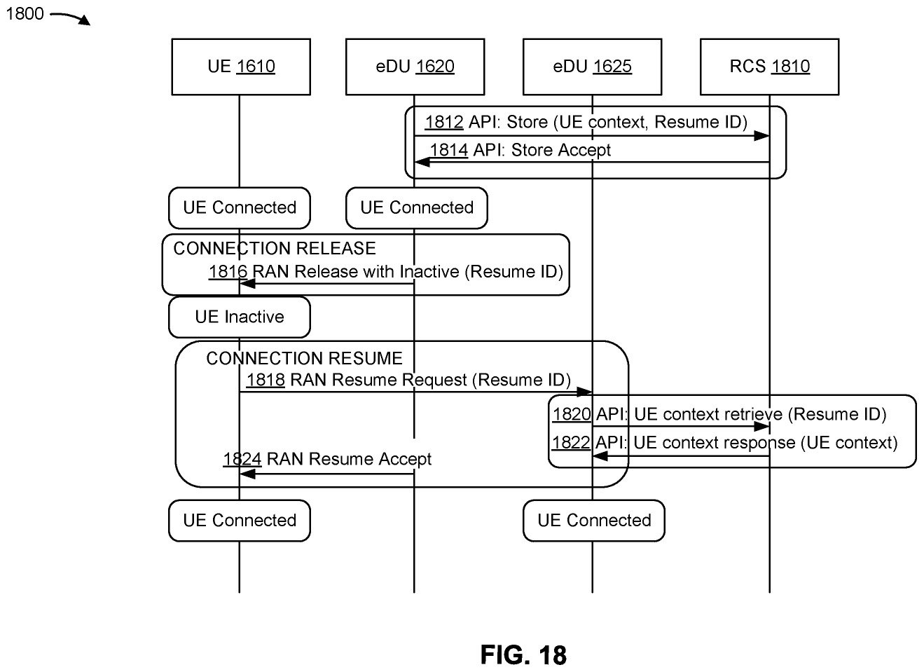

FIG. 18 is a diagram illustrating an example 1800 of UE context management, in accordance with the present disclosure.

In some aspects, the eDU 1620 and the eDU 1625 may communicate with an RCS 1810 (e.g., network node 110, core network node 130). The RCS 1810 may store UE contexts and may be accessible by multiple eDUs over a large geographical area. Multiple eDUs may store UE contexts with resume IDs at the RCS 1810. As shown by reference number 1812, the eDU 1620 may transmit a store message with a UE context and an associated resume ID to the RCS 1810. As shown by reference number 1814, the RCS 1810 may transmit a store accept message to the eDU 1620. The UE 1610 may be connected to the eDU 1620.

The UE 1610 may go inactive. As shown by reference number 1816, the eDU 1620 may transmit a RAN release message with a resume ID to the UE 1610. The UE 1610 may be inactive. As shown by reference number 1818, the UE 1610 may transmit a RAN resume request message with the resume ID to the eDU 1625. As shown by reference number 1820, the eDU 1625 may transmit a UE context retrieve message with the resume ID to the RCS 1810. As shown by reference number 1822, the RCS 1810 may transmit a UE context response message with the UE context to the eDU 1625. As shown by reference number 1824, the eDU 1625 may transmit a RAN resume accept message to the UE 1610. The UE 1610 is now connected to the eDU 1625.

As indicated above, FIG. 18 is provided as an example. Other examples may differ from what is described with regard to FIG. 18.

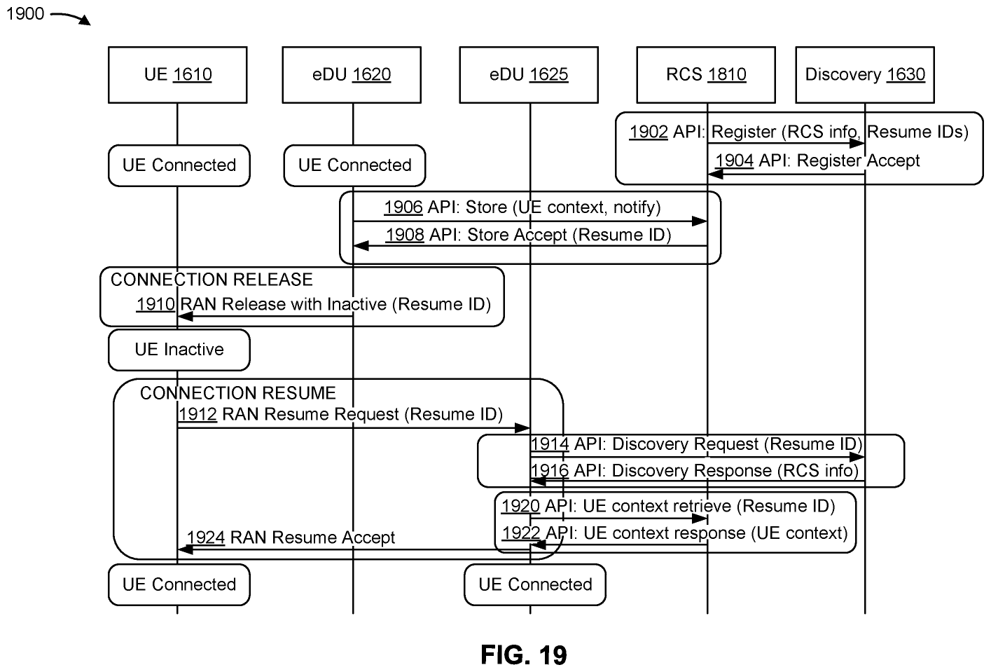

FIG. 19 is a diagram illustrating an example 1900 of UE context management, in accordance with the present disclosure.

In some aspects, UE context management may involve both the RCS 1810 and the discovery entity 1630. The RCS 1810 may be responsible for UE context storage, and the discovery entity 1630 may be responsible for pointing eDUs to the RCS 1810. The RCS 1810 may register with the discovery entity 1630. As shown by reference number 1902, the RCS 1810 may transmit a registration message to the discovery entity 1630. The registration message may include RCS information (e.g., identification information, IP address) and resume IDs. As shown by reference number 1904, the discovery entity 1630 may transmit a registration accept message to the RCS 1810.

The eDU 1620 may store UE contexts for UEs at the RCS 1810. As shown by reference number 1906, the eDU 1620 (connected to the UE 1610) may transmit a store message with a UE context for the UE 1610 to the RCS 1810. As shown by reference number 1908, the RCS 1810 may transmit a store accept message. The RCS 1810 may provide a resume ID in the store accept message. The eDU 1620 may remove the UE context locally from the eDU 1620. In some aspects, the eDU 1625 may host the RCS 1810 within the eDU 1625.

As shown by reference number 1910, the eDU 1620 may transit a RAN release message with a resume ID to the UE 1610. The UE 1610 may go inactive. The UE 1610 may then connect to the eDU 1625. As shown by reference number 1912, the UE 1610 may transmit a RAN resume request message with a resume ID to the eDU 1625.

The eDU 1625 may discover the RCS information by contacting the discovery entity 1630. The eDU 1625 may have also stored the RCS information from a previous discovery or an OAM configuration. As shown by reference number 1914, the eDU 1625 may transmit a discovery request message with the resume ID to the discovery entity 1630. As shown by reference number 1916, the discovery entity 1630 may transmit a discovery response message with the RCS information to the eDU 1625. As shown by reference number 1920, the eDU 1625 may transmit a UE context retrieve message with the resume ID to the RCS 1810. As shown by reference number 1922, the RCS 1810 may transmit a UE context response message with the UE context to the eDU 1625. As shown by reference number 1924, the eDU 1625 may transmit a RAN resume accept message to the UE 1610.

In some aspects, the network may maintain some security for the UE 1610. The UE 1610 may use an authentication token for the network to authenticate the UE 1610. Depending on the size of the RAN resume request message, the UE 1610 may include at least a subset of a message authentication code-integrity (MAC-I) using an AS security configuration. The eDU 1620 or the RCS 1810 may authenticate the UE 1610. In some aspects, a new key may be derived to be used by the eDU 1625. The eDU 1625 may derive the new key with interaction with a security service. Alternatively, or additionally, the RCS 1810 may interact with the security service to derive the new key and provide the new key to the eDU 1625.

As indicated above, FIG. 19 is provided as an example. Other examples may differ from what is described with regard to FIG. 19.

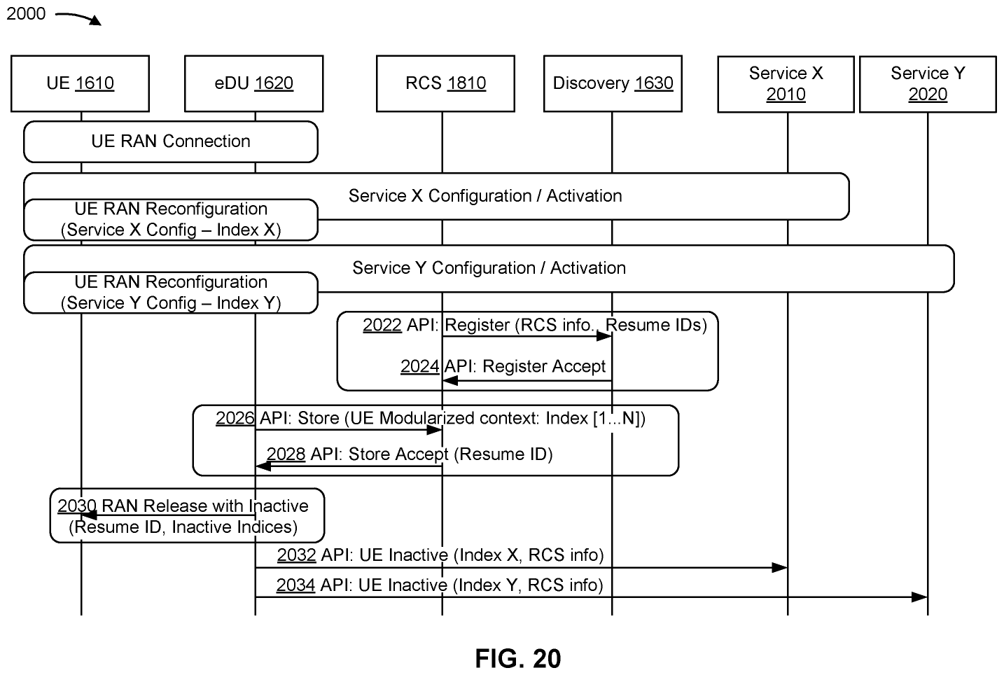

FIG. 20 is a diagram illustrating an example 2000 of using modularized UE contexts, in accordance with the present disclosure.

In some aspects, there may be two types of UE contexts: service-specific UE contexts and non-service-specific UE contexts. A service-specific UE context may be specific to a service request or a configuration. An RB configuration may be associated with a data service request. An AS security configuration may be dependent on a security service. A measurement configuration may be dependent on a mobility service. A non-service-specific UE context may not depend on a specific service. Non-service-specific UE contexts may not be related to any specific service request.

In some aspects, the UE context may be modularized for a service. Each service-specific UE modularized context may be indexed as a UE context module at a storage entity (e.g., RCS 1810). During a RAN configuration or a reconfiguration of the UE 1610, the eDU 1620 may provide different types of configurations as indexed UE context modules. In some aspects, there may be dependencies between modules, where if one module is selected, one or more other modules may be activated with the selected module.

Example 2000 shows the use of a UE modularized context. The UE 1610 may have a service X configuration with a service X (shown as service 2010) and a service Y configuration with a service Y (shown as service 2020). Service X may be identified with index X, and service Y may be identified with index Y. During a service configuration in the eDU 1620, the eDU 1620 may assign an index to the UE modularized context associated with a service (e.g., to the DRB configuration for a data service) and provide the index to the UE 1610 and the service.

The RCS 1810 may register with the discovery entity 1630. As shown by reference number 2022, the RCS 1810 may transmit a register message with RCS information and resume IDs to the discovery entity 1630. As shown by reference number 2024, the discovery entity 1630 may transmit a register accept message to the RCS 1810. The eDU 1620 may store one or more UE context modules that represent UE modularized contexts (within corresponding indices) at the RCS 1810. As shown by reference number 2026, the eDU 1620 may transmit a store message to the RCS 1810, indicating the one or more UE modularized contexts to the RCS 1810. As shown by reference number 2028, the RCS 1810 may transmit a store accept message with a resume ID to the eDU 1620.

The UE 1610 may then go inactive. As shown by reference number 2030, the eDU 1620 may transmit a RAN release message with the resume ID and indices for services that are to go inactive (e.g., index X, index Y). During the RAN release message, the eDU 1620 may provide the UE 1610 which UE modularized contexts are to be kept inactive (and which ones are to be removed). The eDU 1620 may use a bitmap to indicate which UE context modules are to be kept as inactive. The eDU 1620 may indicate with the bitmap or another bitmap which services to remove. That is, a service may be released for which the UE modularized context is only relevant while the UE is connected. The eDU 1620 may provide the service with an indication that the UE 1610 is inactive. The eDU 1620 may indicate, to the service, that the RAN context related to the service is inactive.

For service-specific RAN configuration modules, the eDU 1620 may indicate to the specific service the index number of the UE modularized context. If the UE modularized context is stored in the RCS 1810, the eDU 1620 may provide the RCS information for contacting the RCS 1810. The RCS information may be used by a service to, for example, remove the UE context module related to the service if the service-specific UE modularized context is no longer valid (e.g., needs to be changed/reconfigured or removed completely). As shown by reference number 2032, the eDU 1620 may transmit a UE inactive message with index X and RCS information to the service X. Service X may be inactive for the UE 1610. As shown by reference number 2034, the eDU 1620 may transmit a UE inactive message with index Y and RCS information to service Y. Service Y may be inactive for the UE 1610.

As indicated above, FIG. 20 is provided as an example. Other examples may differ from what is described with regard to FIG. 20.

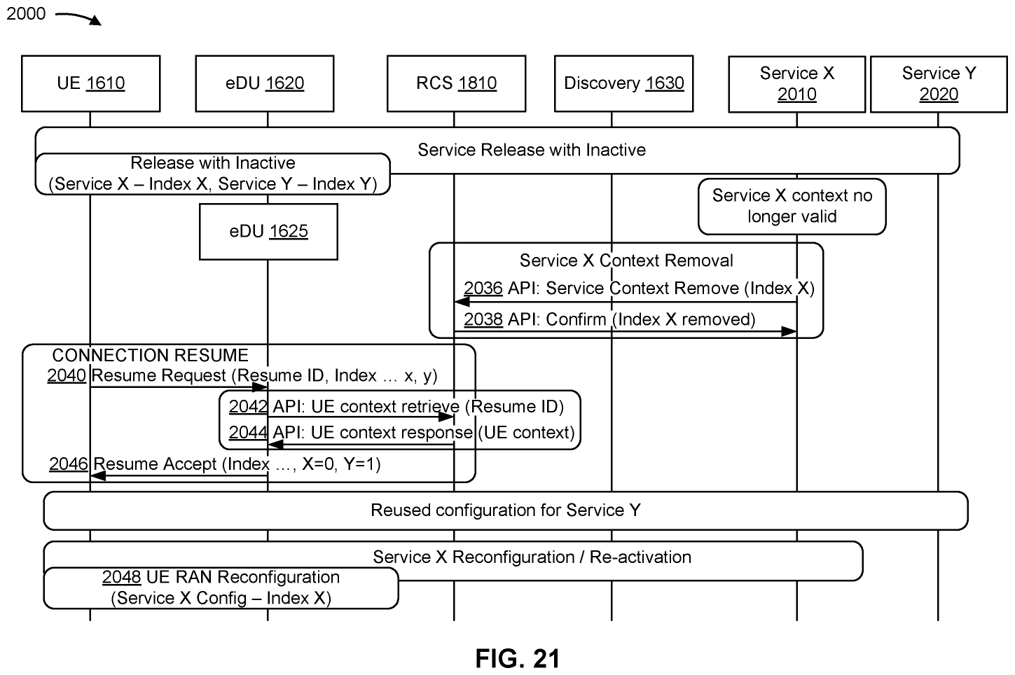

FIG. 21 is a diagram illustrating a continuation of the example 2000 of using modularized UE contexts, in accordance with the present disclosure. Following the inactivation of service X and service Y (shown in FIG. 20), the services may be inactive.

If the service X context for the UE 1610 is no longer valid (e.g., QoS is to be modified in a data service), service X may request that the RCS 1810 set the context for service X to “invalid” (using an index provided by the eDU 1620). The RCS 1810 may set the UE context module for the UE modularized context for service X as “invalid.” The RCS 1810 may confirm this to service X.

In some aspects, service-specific UE contexts (UE modularized contexts) may be removed. If a service determines that a UE modularized context, such as for service X, is no longer valid, or needs to be modified, the service may request the RCS 1810 and/or the eDU 1620 (depending on the UE context storage implementation) to set the UE context module for service X as “invalid” (as an invalid context). The RCS 1810 (or the eDU 1620) may set the UE context module for service X as “invalid.” If any other UE context module is dependent on this context, it is also marked as invalid. Service-specific UE contexts for service indices not included with the resume ID by the UE 1610 may be maintained as inactive. Inactive may include not being activated but still considered valid for resumption. Service-specific contexts for service indices included with the resume ID by the UE 1610 but not indicated as valid in the response may be either removed in the UE 1610 or maintained as invalid.

As shown by reference number 2036, the service X may transmit a service context remove message with index X to the RCS 1810. As shown by reference number 2038, the RCS 1810 may transmit a confirm message to the service X, indicating that index X has been removed.

Note that the eDU 1625 is now part of example 2000 in FIG. 21, as the UE 1610 may connect to the eDU 1625. The UE 1610 may indicate (e.g., with a bitmap) which UE context modules to resume. In example 2000, the UE 1610 is to resume both service X and service Y. As shown by reference number 2040, the UE 1610 may transmit a resume request message with a resume ID and indices X and Y. As shown by reference number 2042, the eDU 1620 may transmit a UE context retrieve message with the resume ID to the RCS 1810.

The eDU 1625 may receive UE modularized contexts from the RCS 1810 with an indication of which UE context modules are still valid (e.g., via bitmap, where ones indicate valid, zeros invalid). In example 2000, service X is no longer valid. As shown by reference number 2044, the RCS 1810 may transmit a UE context response message with a UE modularized context for service Y. The response message may indicate that service X is invalid. The eDU 1625 may now have information that service X is invalid. As shown by reference number 2046, the eDU 1625 may transmit a resume accept message to the UE 1610, indicating, with indices, that service X is invalid and service Y is valid.

The UE 1610 may reuse a configuration for service Y. To use service X, the UE 1610 may expect to have service X reconfigured or reactivated. As shown by reference number 2048, the UE 1610 may use a RAN reconfiguration for service X.

As indicated above, FIG. 21 is provided as an example. Other examples may differ from what is described with regard to FIG. 21.

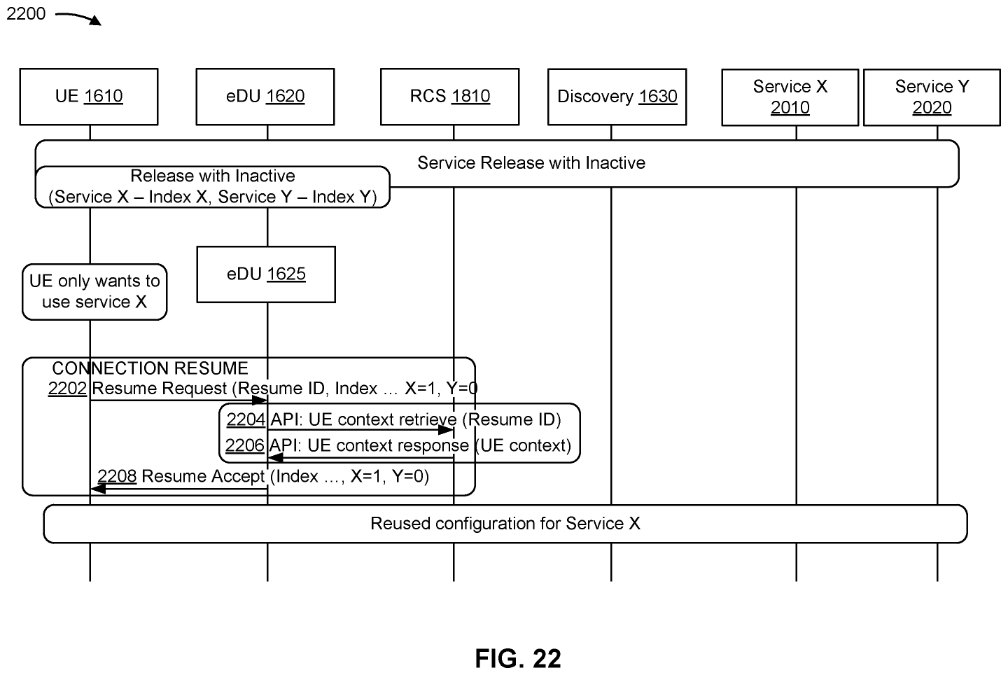

FIG. 22 is a diagram illustrating an example 2200 of using modularized UE contexts, in accordance with the present disclosure. Example 2200 may be a continuation of example 2000.

In some aspects, the UE 1610 may resume a UE modularized context with modularized activation. In a resume request, the UE 1610 may request which specific UE context modules to activate. For example, if the UE 1610 has eMBB and URLLC data services, but only wants to establish a connection for eMBB, then the UE 1610 may indicate to resume eMBB RBs but not URLLC RBs. In the resume response, the eDU 1625 may confirm which UE context modules are to be resumed.

In example 2200 of FIG. 22, service X and service Y are now inactive, but the UE 1610 is to use service X (not service Y). As shown by reference number 2202, the eDU 1625 may transmit a resume request message with a resume ID and an index X for service X. As shown by reference number 2204, the eDU 1625 may transmit a UE context retrieve message with a resume ID to the RCS 1810. As shown by reference number 2206, the RCS 1810 may transmit a UE context response message to the eDU 1625. As shown by reference number 2208, the eDU 1625 may transmit a resume accept message with index X. The UE 1610 may reuse a configuration for service X.

As indicated above, FIG. 22 is provided as an example. Other examples may differ from what is described with regard to FIG. 22.

FIG. 23 is a diagram illustrating an example process 2300 performed, for example, at a UE or an apparatus of a UE, in accordance with the present disclosure. Example process 2300 is an example where the apparatus or the UE (e.g., UE 120, UE 1610) performs operations associated with UE context handling.

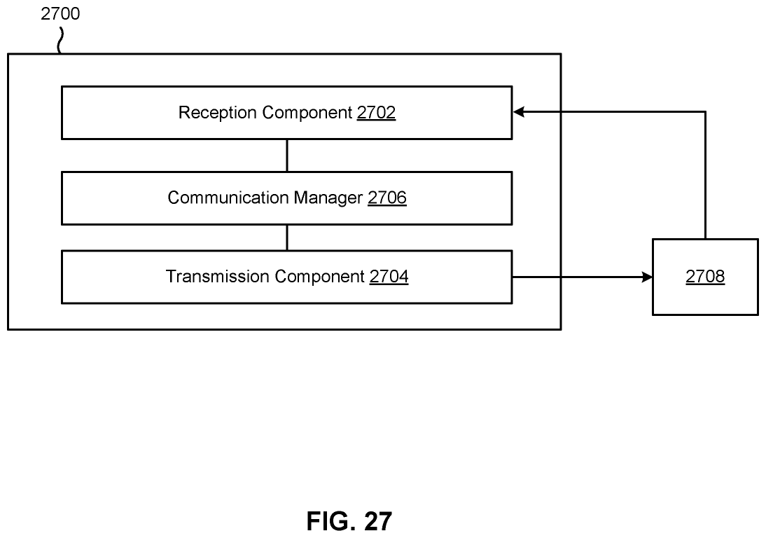

As shown in FIG. 23, in some aspects, process 2300 may include receiving a RAN configuration for a plurality of service modules that correspond to a plurality of services and a plurality of service-specific UE contexts (block 2310). For example, the UE (e.g., using reception component 2702 and/or communication manager 2706, depicted in FIG. 27) may receive a RAN configuration for a plurality of service modules that correspond to a plurality of services and a plurality of service-specific UE contexts, as described above.

As further shown in FIG. 23, in some aspects, process 2300 may include transmitting, while in an inactive state, a resume ID and one or more service indices corresponding to one or more requested services of the plurality of services (block 2320). For example, the UE (e.g., using transmission component 2704 and/or communication manager 2706, depicted in FIG. 27) may transmit, while in an inactive state, a resume ID and one or more service indices corresponding to one or more requested services of the plurality of services, as described above.

As further shown in FIG. 23, in some aspects, process 2300 may include receiving a response indicating one or more valid services of the one or more requested services (block 2330). For example, the UE (e.g., using reception component 2702 and/or communication manager 2706, depicted in FIG. 27) may receive a response indicating one or more valid services of the one or more requested services, as described above.

As further shown in FIG. 23, in some aspects, process 2300 may include transmitting a communication associated with a valid service of the one or more valid services (block 2340). For example, the UE (e.g., using transmission component 2704 and/or communication manager 2706, depicted in FIG. 27) may transmit a communication associated with a valid service of the one or more valid services, as described above.

Process 2300 may include additional aspects, such as any single aspect or any combination of aspects described below and/or in connection with one or more other processes described elsewhere herein.

In a first aspect, a first service of the plurality of services is dependent on a second service of the plurality of services, and a first service-specific UE context corresponding to the first service is used with a second service-specific UE context corresponding to the second service.

In a second aspect, alone or in combination with the first aspect, the response includes one or more valid service indices for the one or more valid services or one or more invalid service indices for one or more invalid services of the one or more requested services.

In a third aspect, alone or in combination with one or more of the first and second aspects, the RAN configuration includes an RB configuration for a data service.

In a fourth aspect, alone or in combination with one or more of the first through third aspects, the RAN configuration includes an AS security configuration for a security service.

In a fifth aspect, alone or in combination with one or more of the first through fourth aspects, the RAN configuration includes a measurement configuration for a mobility service.

Although FIG. 23 shows example blocks of process 2300, in some aspects, process 2300 may include additional blocks, fewer blocks, different blocks, or differently arranged blocks than those depicted in FIG. 23. Additionally, or alternatively, two or more of the blocks of process 2300 may be performed in parallel.

FIG. 24 is a diagram illustrating an example process 2400 performed, for example, at a first network entity or an apparatus of a first network entity, in accordance with the present disclosure. Example process 2400 is an example where the apparatus or the first network entity (e.g., network node 110, core network node 130, RCS 1810) performs operations associated with UE context handling.

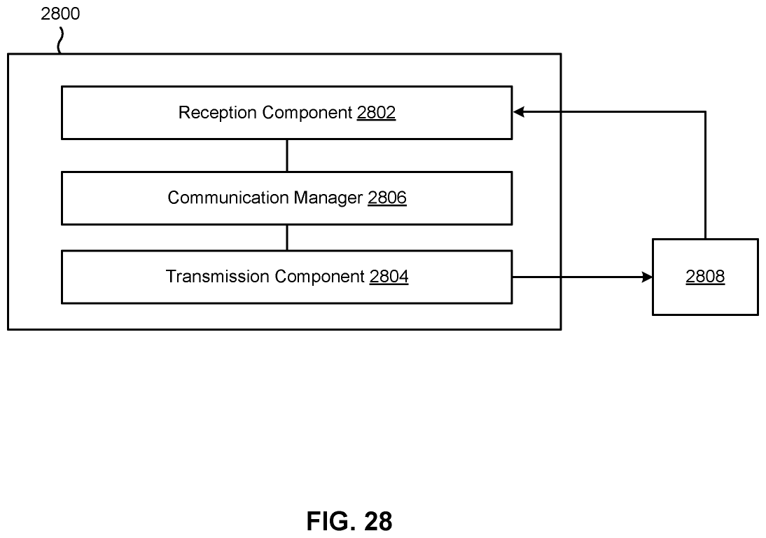

As shown in FIG. 24, in some aspects, process 2400 may include receiving, from a second network entity, a resume ID having identifying information associated with retrieving a UE context for a UE (block 2410). For example, the first network entity (e.g., using reception component 2802 and/or communication manager 2806, depicted in FIG. 28) may receive, from a second network entity, a resume ID having identifying information associated with retrieving a UE context for a UE, as described above.

As further shown in FIG. 24, in some aspects, process 2400 may include transmitting, to the second network entity, a response associated with the UE context (block 2420). For example, the first network entity (e.g., using transmission component 2804 and/or communication manager 2806, depicted in FIG. 28) may transmit, to the second network entity, a response associated with the UE context, as described above.

Process 2400 may include additional aspects, such as any single aspect or any combination of aspects described below and/or in connection with one or more other processes described elsewhere herein.

In a first aspect, process 2400 includes receiving the UE context from a third network entity, and the response includes the UE context.

In a second aspect, alone or in combination with the first aspect, process 2400 includes transmitting registration information for the first network entity to a fourth network entity.

In a third aspect, alone or in combination with one or more of the first and second aspects, process 2400 includes authenticating the UE using a derived security key.

In a fourth aspect, alone or in combination with one or more of the first through third aspects, process 2400 includes deriving a security key, and transmitting the security key to the second network entity.

In a fifth aspect, alone or in combination with one or more of the first through fourth aspects, process 2400 includes storing a plurality of service indices corresponding to a plurality of services and a plurality of service-specific UE contexts.

In a sixth aspect, alone or in combination with one or more of the first through fifth aspects, the UE context is a service-specific UE context, and process 2400 includes receiving, with the resume ID, a service index corresponding to a service and the service-specific UE context.

In a seventh aspect, alone or in combination with one or more of the first through sixth aspects, process 2400 includes maintaining service-specific UE contexts for service indices not included with the resume ID as inactive.

In an eighth aspect, alone or in combination with one or more of the first through seventh aspects, process 2400 includes maintaining service-specific UE contexts for service indices included with the resume ID and not indicated as valid in the response as invalid.

In a ninth aspect, alone or in combination with one or more of the first through eighth aspects, process 2400 includes receiving, from a service, a request to set a service-specific UE context, corresponding to the service, to an invalid context, and setting a service module corresponding to the service to an invalid context.

In a tenth aspect, alone or in combination with one or more of the first through ninth aspects, process 2400 includes receiving, with the resume ID, a service index corresponding to the service, and the response indicates that the service is invalid.

Although FIG. 24 shows example blocks of process 2400, in some aspects, process 2400 may include additional blocks, fewer blocks, different blocks, or differently arranged blocks than those depicted in FIG. 24. Additionally, or alternatively, two or more of the blocks of process 2400 may be performed in parallel.

FIG. 25 is a diagram illustrating an example process 2500 performed, for example, at a first network entity or an apparatus of a first network entity, in accordance with the present disclosure. Example process 2500 is an example where the apparatus or the first network entity (e.g., network node 110, eDU 1625) performs operations associated with UE context handling.

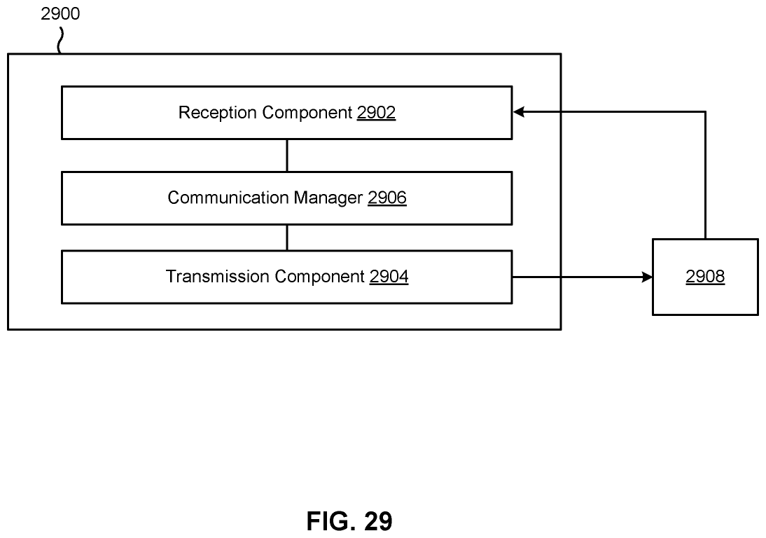

As shown in FIG. 25, in some aspects, process 2500 may include receiving a resume ID from a UE, the resume ID having identifying information associated with retrieving a UE context for the UE (block 2510). For example, the first network entity (e.g., using reception component 2902 and/or communication manager 2906, depicted in FIG. 29) may receive a resume ID from a UE, as described above. The resume ID may have identifying information associated with retrieving a UE context for the UE.

As further shown in FIG. 25, in some aspects, process 2500 may include transmitting the resume ID to a second network entity (block 2520). For example, the first network entity (e.g., using transmission component 2904 and/or communication manager 2906, depicted in FIG. 29) may transmit the resume ID to a second network entity, as described above.

As further shown in FIG. 25, in some aspects, process 2500 may include receiving the UE context (block 2530). For example, the first network entity (e.g., using reception component 2902 and/or communication manager 2906, depicted in FIG. 29) may receive the UE context, as described above.

As further shown in FIG. 25, in some aspects, process 2500 may include transmitting a response to the UE (block 2540). For example, the first network entity (e.g., using transmission component 2904 and/or communication manager 2906, depicted in FIG. 29) may transmit a response to the UE, as described above.

Process 2500 may include additional aspects, such as any single aspect or any combination of aspects described below and/or in connection with one or more other processes described elsewhere herein.

In a first aspect, receiving the UE context includes receiving the UE context from the second network entity.

In a second aspect, alone or in combination with the first aspect, process 2500 includes transmitting registration information for the first network entity to the second network entity.

In a third aspect, alone or in combination with one or more of the first and second aspects, process 2500 includes transmitting a UE context for the UE at the first network entity to the second network entity.

In a fourth aspect, alone or in combination with one or more of the first through third aspects, process 2500 includes receiving information for a third network entity, and transmitting the resume ID to the third network entity, where receiving the UE context includes receiving the UE context from the third network entity.

In a fifth aspect, alone or in combination with one or more of the first through fourth aspects, process 2500 includes authenticating the UE using a security key.

In a sixth aspect, alone or in combination with one or more of the first through fifth aspects, process 2500 includes deriving or receiving the security key.

In a seventh aspect, alone or in combination with one or more of the first through sixth aspects, process 2500 includes receiving, from a service, a request to set a service-specific UE context corresponding to the service to an invalid context, and setting a service module corresponding to the service to an invalid context.

In an eighth aspect, alone or in combination with one or more of the first through seventh aspects, process 2500 includes receiving a service index corresponding to the service, where the response indicates that the service is invalid.

In a ninth aspect, alone or in combination with one or more of the first through eighth aspects, the UE context is a service-specific UE context, and process 2500 includes receiving, with the resume ID, a service index corresponding to a service and the service-specific UE context.

Although FIG. 25 shows example blocks of process 2500, in some aspects, process 2500 may include additional blocks, fewer blocks, different blocks, or differently arranged blocks than those depicted in FIG. 25. Additionally, or alternatively, two or more of the blocks of process 2500 may be performed in parallel.

FIG. 26 is a diagram illustrating an example process 2600 performed, for example, at a first network entity or an apparatus of a first network entity, in accordance with the present disclosure. Example process 2600 is an example where the apparatus or the first network entity (e.g., network node 110, core network node 130, discovery entity 1630) performs operations associated with UE context handling.

As shown in FIG. 26, in some aspects, process 2600 may include receiving registration information from a second network entity that stores a UE context (block 2610). For example, the first network entity (e.g., using reception component 2802 and/or communication manager 2806, depicted in FIG. 28) may receive registration information from a second network entity that stores a UE context, as described above.

As further shown in FIG. 26, in some aspects, process 2600 may include receiving, from a third network entity, a resume ID having identifying information associated with retrieving the UE context (block 2620). For example, the first network entity (e.g., using reception component 2802 and/or communication manager 2806, depicted in FIG. 28) may receive, from a third network entity, a resume ID having identifying information associated with retrieving the UE context, as described above.

As further shown in FIG. 26, in some aspects, process 2600 may include transmitting a response associated with the UE context (block 2630). For example, the first network entity (e.g., using transmission component 2804 and/or communication manager 2806, depicted in FIG. 28) may transmit a response associated with the UE context, as described above.

Process 2600 may include additional aspects, such as any single aspect or any combination of aspects described below and/or in connection with one or more other processes described elsewhere herein.

In a first aspect, the response includes information about the second network entity.

In a second aspect, alone or in combination with the first aspect, the second network entity is a source RAN node.

In a third aspect, alone or in combination with one or more of the first and second aspects, the second network entity is an RCS node.

Although FIG. 26 shows example blocks of process 2600, in some aspects, process 2600 may include additional blocks, fewer blocks, different blocks, or differently arranged blocks than those depicted in FIG. 26. Additionally, or alternatively, two or more of the blocks of process 2600 may be performed in parallel.

FIG. 27 is a diagram of an example apparatus 2700 for wireless communication, in accordance with the present disclosure. The apparatus 2700 may be a UE (e.g., UE 120, UE 1610), or a UE may include the apparatus 2700. In some aspects, the apparatus 2700 includes a reception component 2702, a transmission component 2704, and/or a communication manager 2706, which may be in communication with one another (for example, via one or more buses and/or one or more other components). In some aspects, the communication manager 2706 is the communication manager 140 described in connection with FIG. 1. As shown, the apparatus 2700 may communicate with another apparatus 2708, such as a UE or a network node (such as a CU, a DU, an RU, or a base station), using the reception component 2702 and the transmission component 2704.

In some aspects, the apparatus 2700 may be configured to perform one or more operations described herein in connection with FIGS. 1-22. Additionally, or alternatively, the apparatus 2700 may be configured to perform one or more processes described herein, such as process 2300 of FIG. 23. In some aspects, the apparatus 2700 and/or one or more components shown in FIG. 27 may include one or more components of the UE described in connection with FIG. 2. Additionally, or alternatively, one or more components shown in FIG. 27 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2702 may receive communications, such as reference signals, control information, data communications, or a combination thereof, from the apparatus 2708. The reception component 2702 may provide received communications to one or more other components of the apparatus 2700. In some aspects, the reception component 2702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2700. In some aspects, the reception component 2702 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 2704 may transmit communications, such as reference signals, control information, data communications, or a combination thereof, to the apparatus 2708. In some aspects, one or more other components of the apparatus 2700 may generate communications and may provide the generated communications to the transmission component 2704 for transmission to the apparatus 2708. In some aspects, the transmission component 2704 may perform signal processing on the generated communications (such as filtering, amplification, modulation, digital-to-analog conversion, multiplexing, interleaving, mapping, or encoding, among other examples), and may transmit the processed signals to the apparatus 2708. In some aspects, the transmission component 2704 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 2704 may be co-located with the reception component 2702 in one or more transceivers.

The communication manager 2706 may support operations of the reception component 2702 and/or the transmission component 2704. For example, the communication manager 2706 may receive information associated with configuring reception of communications by the reception component 2702 and/or transmission of communications by the transmission component 2704. Additionally, or alternatively, the communication manager 2706 may generate and/or provide control information to the reception component 2702 and/or the transmission component 2704 to control reception and/or transmission of communications.

In some aspects, the reception component 2702 may receive a RAN configuration for a plurality of service modules that correspond to a plurality of services and a plurality of service-specific UE contexts. The transmission component 2704 may transmit, while in an inactive state, a resume ID and one or more service indices corresponding to one or more requested services of the plurality of services. The reception component 2702 may receive a response indicating one or more valid services of the one or more requested services. The transmission component 2704 may transmit a communication associated with a valid service of the one or more valid services.

The number and arrangement of components shown in FIG. 27 are provided as an example. In practice, there may be additional components, fewer components, different components, or differently arranged components than those shown in FIG. 27. Furthermore, two or more components shown in FIG. 27 may be implemented within a single component, or a single component shown in FIG. 27 may be implemented as multiple, distributed components. Additionally, or alternatively, a set of (one or more) components shown in FIG. 27 may perform one or more functions described as being performed by another set of components shown in FIG. 27.

FIG. 28 is a diagram of an example apparatus 2800 for wireless communication, in accordance with the present disclosure. The apparatus 2800 may be a first network entity (e.g., core network node 130, RCS 1810, discovery entity 1630), or a first network entity may include the apparatus 2800. In some aspects, the apparatus 2800 includes a reception component 2802, a transmission component 2804, and/or a communication manager 2806, which may be in communication with one another (for example, via one or more buses and/or one or more other components). In some aspects, the communication manager 2806 is the communication manager 160 described in connection with FIG. 1. As shown, the apparatus 2800 may communicate with another apparatus 2808, such as a UE or a network node (such as a CU, a DU, an RU, or a base station), using the reception component 2802 and the transmission component 2804.

In some aspects, the apparatus 2800 may be configured to perform one or more operations described herein in connection with FIGS. 1-22. Additionally, or alternatively, the apparatus 2800 may be configured to perform one or more processes described herein, such as process 2400 of FIG. 24, process 2600 of FIG. 26, or a combination thereof. In some aspects, the apparatus 2800 and/or one or more components shown in FIG. 28 may include one or more components of the first network entity described in connection with FIG. 2. Additionally, or alternatively, one or more components shown in FIG. 28 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2802 may receive communications, such as reference signals, control information, data communications, or a combination thereof, from the apparatus 2808. The reception component 2802 may provide received communications to one or more other components of the apparatus 2800. In some aspects, the reception component 2802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2800. In some aspects, the reception component 2802 may include one or more antennas, one or more modems, one or more demodulators, one or more MIMO detectors, one or more receive processors, one or more controllers/processors, one or more memories, or a combination thereof, of the first network entity described in connection with FIG. 2.

The transmission component 2804 may transmit communications, such as reference signals, control information, data communications, or a combination thereof, to the apparatus 2808. In some aspects, one or more other components of the apparatus 2800 may generate communications and may provide the generated communications to the transmission component 2804 for transmission to the apparatus 2808. In some aspects, the transmission component 2804 may perform signal processing on the generated communications (such as filtering, amplification, modulation, digital-to-analog conversion, multiplexing, interleaving, mapping, or encoding, among other examples), and may transmit the processed signals to the apparatus 2808. In some aspects, the transmission component 2804 may include one or more antennas, one or more modems, one or more modulators, one or more transmit MIMO processors, one or more transmit processors, one or more controllers/processors, one or more memories, or a combination thereof, of the first network entity described in connection with FIG. 2. In some aspects, the transmission component 2804 may be co-located with the reception component 2802 in one or more transceivers.

The communication manager 2806 may support operations of the reception component 2802 and/or the transmission component 2804. For example, the communication manager 2806 may receive information associated with configuring reception of communications by the reception component 2802 and/or transmission of communications by the transmission component 2804. Additionally, or alternatively, the communication manager 2806 may generate and/or provide control information to the reception component 2802 and/or the transmission component 2804 to control reception and/or transmission of communications.

In some aspects where the first network entity is operating as an RCS, the reception component 2802 may receive, from a second network entity (e.g., target eDU), a resume ID having identifying information associated with retrieving a UE context for a UE. The transmission component 2804 may transmit, to the second network entity, a response associated with the UE context. The reception component 2802 may receive the UE context from a third network entity (e.g., source eDU), and the response includes the UE context. The transmission component 2804 may transmit registration information for the first network entity to a fourth network entity (e.g., discovery entity).

The communication manager 2806 may authenticate the UE using a derived security key. The communication manager 2806 may derive a security key. The transmission component 2804 may transmit the security key to the second network entity.

The communication manager 2806 may store a plurality of service indices corresponding to a plurality of services and a plurality of service-specific UE contexts. The reception component 2802 may receive, from a service, a request to set a service-specific UE context, corresponding to the service, to an invalid context. The communication manager 2806 may set a service module corresponding to the service to an invalid context. The reception component 2802 may receive, with the resume ID, a service index corresponding to the service, and the response indicates that the service is invalid.

In some aspects where the first network entity is operating as a discovery entity, the reception component 2802 may receive registration information from a second network entity (e.g., source eDU, RCS) that stores a UE context. The reception component 2802 may receive, from a third network entity (e.g., target eDU), a resume ID having identifying information associated with retrieving the UE context. The transmission component 2804 may transmit a response associated with the UE context.

The number and arrangement of components shown in FIG. 28 are provided as an example. In practice, there may be additional components, fewer components, different components, or differently arranged components than those shown in FIG. 28. Furthermore, two or more components shown in FIG. 28 may be implemented within a single component, or a single component shown in FIG. 28 may be implemented as multiple, distributed components. Additionally, or alternatively, a set of (one or more) components shown in FIG. 28 may perform one or more functions described as being performed by another set of components shown in FIG. 28.

FIG. 29 is a diagram of an example apparatus 2900 for wireless communication, in accordance with the present disclosure. The apparatus 2900 may be a first network entity (e.g., network node 110, eDU 1625), or a first network entity may include the apparatus 2900. In some aspects, the apparatus 2900 includes a reception component 2902, a transmission component 2904, and/or a communication manager 2906, which may be in communication with one another (for example, via one or more buses and/or one or more other components). In some aspects, the communication manager 2906 is the communication manager 150 described in connection with FIG. 1. As shown, the apparatus 2900 may communicate with another apparatus 2908, such as a UE or a network node (such as a CU, a DU, an RU, or a base station), using the reception component 2902 and the transmission component 2904.

In some aspects, the apparatus 2900 may be configured to perform one or more operations described herein in connection with FIGS. 1-22. Additionally, or alternatively, the apparatus 2900 may be configured to perform one or more processes described herein, such as process 2500 of FIG. 25. In some aspects, the apparatus 2900 and/or one or more components shown in FIG. 29 may include one or more components of the first network entity described in connection with FIG. 2. Additionally, or alternatively, one or more components shown in FIG. 29 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2902 may receive communications, such as reference signals, control information, data communications, or a combination thereof, from the apparatus 2908. The reception component 2902 may provide received communications to one or more other components of the apparatus 2900. In some aspects, the reception component 2902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2900. In some aspects, the reception component 2902 may include one or more antennas, one or more modems, one or more demodulators, one or more MIMO detectors, one or more receive processors, one or more controllers/processors, one or more memories, or a combination thereof, of the first network entity described in connection with FIG. 2.

The transmission component 2904 may transmit communications, such as reference signals, control information, data communications, or a combination thereof, to the apparatus 2908. In some aspects, one or more other components of the apparatus 2900 may generate communications and may provide the generated communications to the transmission component 2904 for transmission to the apparatus 2908. In some aspects, the transmission component 2904 may perform signal processing on the generated communications (such as filtering, amplification, modulation, digital-to-analog conversion, multiplexing, interleaving, mapping, or encoding, among other examples), and may transmit the processed signals to the apparatus 2908. In some aspects, the transmission component 2904 may include one or more antennas, one or more modems, one or more modulators, one or more transmit MIMO processors, one or more transmit processors, one or more controllers/processors, one or more memories, or a combination thereof, of the first network entity described in connection with FIG. 2. In some aspects, the transmission component 2904 may be co-located with the reception component 2902 in one or more transceivers.

The communication manager 2906 may support operations of the reception component 2902 and/or the transmission component 2904. For example, the communication manager 2906 may receive information associated with configuring reception of communications by the reception component 2902 and/or transmission of communications by the transmission component 2904. Additionally, or alternatively, the communication manager 2906 may generate and/or provide control information to the reception component 2902 and/or the transmission component 2904 to control reception and/or transmission of communications.

In some aspects where the first network entity is operating as a RAN node (e.g. eDU), the reception component 2902 may receive a resume ID from a UE, the resume ID having identifying information associated with retrieving a UE context for the UE. The transmission component 2904 may transmit the resume ID to a second network entity (e.g., discovery entity, RCS, source eDU). The reception component 2902 may receive the UE context. The transmission component 2904 may transmit a response to the UE.

The transmission component 2904 may transmit registration information for the first network entity to the second network entity. The transmission component 2904 may transmit a UE context for the UE at the first network entity to the second network entity.

The reception component 2902 may receive information for a third network entity.

The transmission component 2904 may transmit the resume ID to the third network entity, where receiving the UE context includes receiving the UE context from the third network entity.

The communication manager 2906 may authenticate the UE using a security key. The communication manager 2906 may derive or receive the security key.

The reception component 2902 may receive, from a service, a request to set a service-specific UE context corresponding to the service to an invalid context. The communication manager 2906 may set a service module corresponding to the service to an invalid context. The reception component 2902 may receive a service index corresponding to the service, wherein the response indicates that the service is invalid.

The following provides an overview of some Aspects of the present disclosure:
Aspect 1: A method of wireless communication performed by a user equipment (UE), comprising: receiving a radio access network (RAN) configuration for a plurality of service modules that correspond to a plurality of services and a plurality of service-specific UE contexts; transmitting, while in an inactive state, a resume identifier (ID) and one or more service indices corresponding to one or more requested services of the plurality of services; receiving a response indicating one or more valid services of the one or more requested services; and transmitting a communication associated with a valid service of the one or more valid services.
Aspect 2: The method of Aspect 1, wherein a first service of the plurality of services is dependent on a second service of the plurality of services, and wherein a first service-specific UE context corresponding to the first service is used with a second service-specific UE context corresponding to the second service.
Aspect 3: The method of any of Aspects 1-2, wherein the response includes one or more valid service indices for the one or more valid services or one or more invalid service indices for one or more invalid services of the one or more requested services.
Aspect 4: The method of any of Aspects 1-3, wherein the RAN configuration includes a resource block configuration for a data service.
Aspect 5: The method of any of Aspects 1-4, wherein the RAN configuration includes an access stratum security configuration for a security service.
Aspect 6: The method of any of Aspects 1-5, wherein the RAN configuration includes a measurement configuration for a mobility service.
Aspect 7: A method of wireless communication performed by a first network entity, comprising: receiving, from a second network entity, a resume identifier (ID) having identifying information associated with retrieving a user equipment (UE) context for a UE; and transmitting, to the second network entity, a response associated with the UE context.
Aspect 8: The method of Aspect 7, further comprising receiving the UE context from a third network entity, and wherein the response includes the UE context.
Aspect 9: The method of any of Aspects 7-8, further comprising transmitting registration information for the first network entity to a fourth network entity.
Aspect 10: The method of any of Aspects 7-9, further comprising authenticating the UE using a derived security key.
Aspect 11: The method of any of Aspects 7-10, further comprising: deriving a security key; and transmitting the security key to the second network entity.
Aspect 12: The method of any of Aspects 7-11, further comprising storing a plurality of service indices corresponding to a plurality of services and a plurality of service-specific UE contexts.
Aspect 13: The method of Aspect 12, wherein the UE context is a service-specific UE context, and wherein the method includes receiving, with the resume ID, a service index corresponding to a service and the service-specific UE context.
Aspect 14: The method of Aspect 13, further comprising further comprising maintaining service-specific UE contexts for service indices not included with the resume ID as inactive.
Aspect 15: The method of Aspect 13, further comprising further comprising maintaining service-specific UE contexts for service indices included with the resume ID and not indicated as valid in the response as invalid.
Aspect 16: The method of any of Aspects 7-15, further comprising: receiving, from a service, a request to set a service-specific UE context, corresponding to the service, to an invalid context; and setting a service module corresponding to the service to the invalid context.
Aspect 17: The method of Aspect 16, further comprising receiving, with the resume ID, a service index corresponding to the service, and wherein the response indicates that the service is invalid.
Aspect 18: A method of wireless communication performed by a first network entity, comprising: receiving a resume identifier (ID) from a user equipment (UE), the resume ID having identifying information associated with retrieving a UE context for the UE; transmitting the resume ID to a second network entity; receiving the UE context; and transmitting a response to the UE.
Aspect 19: The method of Aspect 18, wherein receiving the UE context includes receiving the UE context from the second network entity.
Aspect 20: The method of any of Aspects 18-19, further comprising transmitting registration information for the first network entity to the second network entity.
Aspect 21: The method of any of Aspects 18-20, further comprising transmitting a UE context for the UE at the first network entity to the second network entity.
Aspect 22: The method of any of Aspects 18-21, further comprising: receiving information for a third network entity; and transmitting the resume ID to the third network entity, wherein receiving the UE context includes receiving the UE context from the third network entity.
Aspect 23: The method of any of Aspects 18-22, further comprising authenticating the UE using a security key.
Aspect 24: The method of Aspect 23, further comprising deriving or receiving the security key.
Aspect 25: The method of any of Aspects 18-24, further comprising: receiving, from a service, a request to set a service-specific UE context corresponding to the service to an invalid context; and setting a service module corresponding to the service to the invalid context.
Aspect 26: The method of Aspect 25, further comprising receiving a service index corresponding to the service, wherein the response indicates that the service is invalid.
Aspect 27: The method of any of Aspects 18-26, wherein the UE context is a service-specific UE context, and wherein the method includes receiving, with the resume ID, a service index corresponding to a service and the service-specific UE context.
Aspect 28: A method of wireless communication performed by a first network entity, comprising: receiving registration information from a second network entity that stores a user equipment (UE) context; receiving, from a third network entity, a resume identifier (ID) having identifying information associated with retrieving the UE context; and transmitting a response associated with the UE context.
Aspect 29: The method of Aspect 28, wherein the response includes information about the second network entity.
Aspect 30: The method of any of Aspects 28-29, wherein the second network entity is a source radio access network node.
Aspect 31: The method of any of Aspects 28-30, wherein the second network entity is a source radio access network context service (RCS) node.
Aspect 32: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-31.
Aspect 33: An apparatus for wireless communication at a device, the apparatus comprising one or more memories and one or more processors coupled to the one or more memories, the one or more processors configured to cause the device to perform the method of one or more of Aspects 1-31.
Aspect 34: An apparatus for wireless communication, the apparatus comprising at least one means for performing the method of one or more of Aspects 1-31.
Aspect 35: A non-transitory computer-readable medium storing code for wireless communication, the code comprising instructions executable by one or more processors to perform the method of one or more of Aspects 1-31.
Aspect 36: A non-transitory computer-readable medium storing a set of instructions for wireless communication, the set of instructions comprising one or more instructions that, when executed by one or more processors of a device, cause the device to perform the method of one or more of Aspects 1-31.
Aspect 37: A device for wireless communication, the device comprising a processing system that includes one or more processors and one or more memories coupled with the one or more processors, the processing system configured to cause the device to perform the method of one or more of Aspects 1-31.
Aspect 38: An apparatus for wireless communication at a device, the apparatus comprising one or more memories and one or more processors coupled to the one or more memories, the one or more processors individually or collectively configured to cause the device to perform the method of one or more of Aspects 1-31.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication at a user equipment (UE), comprising:
one or more memories; and
one or more processors coupled to the one or more memories, the one or more processors individually or collectively configured to cause the UE to:
receive a radio access network (RAN) configuration for a plurality of service modules that correspond to a plurality of services and a plurality of service-specific UE contexts;
transmit, while in an inactive state, a resume identifier (ID) and one or more service indices corresponding to one or more requested services of the plurality of services;
receive a response indicating one or more valid services of the one or more requested services; and
transmit a communication associated with a valid service of the one or more valid services.

2. The apparatus of claim 1, wherein a first service of the plurality of services is dependent on a second service of the plurality of services, and wherein a first service-specific UE context corresponding to the first service is used with a second service-specific UE context corresponding to the second service.

3. The apparatus of claim 1, wherein the response includes one or more valid service indices for the one or more valid services or one or more invalid service indices for one or more invalid services of the one or more requested services.

4. The apparatus of claim 1, wherein the RAN configuration includes a resource block configuration for a data service.

5. The apparatus of claim 1, wherein the RAN configuration includes an access stratum security configuration for a security service.

6. The apparatus of claim 1, wherein the RAN configuration includes a measurement configuration for a mobility service.

7. An apparatus for wireless communication at a first network entity, comprising:
one or more memories; and
one or more processors coupled to the one or more memories, the one or more processors individually or collectively configured to cause the first network entity to:
receive, from a second network entity, a resume identifier (ID) having identifying information associated with retrieving a user equipment (UE) context for a UE; and
transmit, to the second network entity, a response associated with the UE context.

8. The apparatus of claim 7, wherein the one or more processors are individually or collectively configured to cause the first network entity to receive the UE context from a third network entity, and wherein the response includes the UE context.

9. The apparatus of claim 7, wherein the one or more processors are individually or collectively configured to cause the first network entity to transmit registration information for the first network entity to a fourth network entity.

10. The apparatus of claim 7, wherein the one or more processors are individually or collectively configured to cause the first network entity to authenticate the UE using a derived security key.

11. The apparatus of claim 7, wherein the one or more processors are individually or collectively configured to cause the first network entity to:
derive a security key; and
transmit the security key to the second network entity.

12. The apparatus of claim 7, wherein the one or more processors are individually or collectively configured to cause the first network entity to store a plurality of service indices corresponding to a plurality of services and a plurality of service-specific UE contexts.

13. The apparatus of claim 12, wherein the UE context is a service-specific UE context, and wherein the one or more processors are individually or collectively configured to cause the first network entity to receive with the resume ID, a service index corresponding to a service and the service-specific UE context.

14. The apparatus of claim 13, further comprising maintaining service-specific UE contexts for service indices not included with the resume ID as inactive.

15. The apparatus of claim 13, further comprising maintaining service-specific UE contexts for service indices included with the resume ID and not indicated as valid in the response as invalid.

16. The apparatus of claim 7, wherein the one or more processors are individually or collectively configured to cause the first network entity to:
receive, from a service, a request to set a service-specific UE context, corresponding to the service, to an invalid context; and
set a service module corresponding to the service to the invalid context.

17. The apparatus of claim 16, wherein the one or more processors are individually or collectively configured to cause the first network entity to receive, with the resume ID, a service index corresponding to the service, and wherein the response indicates that the service is invalid.

18. An apparatus for wireless communication at a first network entity, comprising:
one or more memories; and
one or more processors coupled to the one or more memories, the one or more processors individually or collectively configured to cause the first network entity to:
receive a resume identifier (ID) from a user equipment (UE), the resume ID having identifying information associated with retrieving a UE context for the UE;
transmit the resume ID to a second network entity;
receive the UE context; and
transmit a response to the UE.

19. The apparatus of claim 18, wherein to receive the UE context, the one or more processors are individually or collectively configured to cause the first network entity to receive the UE context from the second network entity.

20. The apparatus of claim 18, wherein the one or more processors are individually or collectively configured to cause the first network entity to transmit registration information for the first network entity to the second network entity.

21. The apparatus of claim 18, wherein the one or more processors are individually or collectively configured to cause the first network entity to transmit a UE context for the UE at the first network entity to the second network entity.

22. The apparatus of claim 18, wherein the one or more processors are individually or collectively configured to cause the first network entity to:
receive information for a third network entity; and
transmit the resume ID to the third network entity, wherein to receive the UE context, the one or more processors are individually or collectively configured to cause the first network entity to receive the UE context from the third network entity.

23. The apparatus of claim 18, wherein the one or more processors are individually or collectively configured to cause the first network entity to authenticate the UE using a security key, and wherein the one or more processors are individually or collectively configured to cause the first network entity to derive or receive the security key.

24. The apparatus of claim 18, wherein the one or more processors are individually or collectively configured to cause the first network entity to:
receive, from a service, a request to set a service-specific UE context corresponding to the service to an invalid context; and
set a service module corresponding to the service to the invalid context.

25. The apparatus of claim 24, wherein the one or more processors are individually or collectively configured to cause the first network entity to receive a service index corresponding to the service, wherein the response indicates that the service is invalid.

26. The apparatus of claim 18, wherein the UE context is a service-specific UE context, and wherein the one or more processors are individually or collectively configured to cause the first network entity to receive, with the resume ID, a service index corresponding to a service and the service-specific UE context.

27. An apparatus for wireless communication at a first network entity, comprising:
one or more memories; and
one or more processors coupled to the one or more memories, the one or more processors individually or collectively configured to cause the first network entity to:
receive registration information from a second network entity that stores a user equipment (UE) context;
receive, from a third network entity, a resume identifier (ID) having identifying information associated with retrieving the UE context; and
transmit a response associated with the UE context.

28. The apparatus of claim 27, wherein the response includes information about the second network entity.

29. The apparatus of claim 27, wherein the second network entity is a source radio access network node.

30. The apparatus of claim 27, wherein the second network entity is a source radio access network context service (RCS) node.
